(19) United States
(12) Patent Application Publication
(10) Pub. No.: US 2023/0099808 A1
(43) Pub. Date: Mar. 30, 2023

(54) METHOD AND SYSTEM FOR AUTOMATIC MUSIC TRANSCRIPTION AND SIMPLIFICATION

(71) Applicant: Novel, LLC, Orlando, FL (US)

(72) Inventor: Andrew Nicholas Novoa, Orlando, FL (US)

(73) Assignee: Novel, LLC, Orlando, FL (US)

(21) Appl. No.: 17/957,393

(22) Filed: Sep. 30, 2022

Related U.S. Application Data
(60) Provisional application No. 63/250,321, filed on Sep. 30, 2021.

(51) Int. Cl. G10G 1/04; G10H 1/00

(52) U.S. Cl. CPC G10G 1/04; G10H 1/0008; G10H 2210/381; G10H 2210/341; G10H 2210/571; G10H 2210/086

(57) ABSTRACT

Provided are systems and methods for transforming a digital score file into one or more of a plurality of levels of simplified visualization outputs. Methods of the present invention may be computer implemented. Systems of the present invention may include at least one display device, a non-transitory memory having instructions embedded thereon, and a processor in communication with the non-transitory memory and the at least one display device. Systems and methods of the present invention may be configured to receive at least one digital score file, upon which one or more simplification rules are executed, resulting in at least one simplified visualization output. Simplification rules may include, but are not limited to, song length, tempo adjustment, tie, rhythm, harmonic rhythm, and chord. One or more simplified visualization outputs are then provided.

### FIELD OF THE INVENTION

The present invention is related to musical education, and more particularly is related to the improvement of musical education through simplifying sheet music to accommodate a particular skill level. To that end, this invention also relates to music transcription and more specifically to methods and systems for automatic music transcription with simplification tailored to a user's level.

### BACKGROUND

Learning to play an instrument can be challenging for beginners. Typically, when starting an endeavor such as learning an instrument, it is important to have high motivation, as the learning curve is very steep and it is hard to see results early on. One of the biggest barriers to entry is feeling like one's skills are inadequate to play their desired music. Most learners have an idea of what music they would like to play, but it may be out of technical reach. This can be for many reasons, including but not limited to the original music being too difficult and no versions are available at an easier level. This is a large deterrent to learning most skills and music is no exception.

Prior art sources for music education avoid this problem by requiring learners to play material that is naturally simpler, regardless of whether the learner likes the music or not. However, this can be unrewarding, and, therefore, a common cause that beginners quit playing music is because the simpler music is demotivating.

Ideally, a learner should be able to select any song of their choosing and gain valuable experience and knowledge from it, even if the original skill level required is higher than the learner's. To do this, a method is needed in the art to simplify chosen music into sheet music that is at an attainable level for the learner. It is important for the simplified music resulting from such a method to retain some resemblance to the original. Otherwise, the learner would not feel like they are playing the desired music, and the motivation would be less.

Known in the art are methods and systems, including software, for music transcription. For example, Wu et al. have described Polyphonic Music Transcription with Semantic Segmentation in an article published by the Institute of Electrical and Electronics Engineers (IEEE) in 2019. The authors leverage multi-object semantic segmentation techniques to solve the problem of multi-instrument transcription requiring joint recognition of instrument and pitch of every event in polyphonic music signals generated by one or more classes of music instruments.

Similarly, the Music and Culture Technology Lab provides a music transcription service, Omnizart, that may be used by others, such as educators. However, this program does not provide a transcription that is tailored to the level of the user.

Also known in the art are features in existing software to simplify a digital score. For example, some existing notation software, such as Finale by MakeMusic and Sibelius by Avid, include an option to simplify notation in areas such as tied notes or excessive rests. However, these prior art programs only simplify the aesthetics of sheet music, such as by removing redundancies in the visual product. These methods and programs do not provide simplification for any of the musical elements such as rhythm, score range, etc. Accordingly, needed in the art is a method and program that can automatically simplify music to the ability of the user.

### SUMMARY

Provided are systems and methods for transforming a digital score file into one or more of a plurality of levels of simplified visualization outputs. In some embodiments, such methods may be computer implemented. In one or more embodiments of a computer implemented method of the present invention, the method may include receiving at least one digital score file, receiving one or more inputs related to the plurality of simplification levels, and executing one or more executable instructions. The executed able instructions are located on at least one non-transitory memory. The executable instructions are configured to cause the processor to transcribe the digital score file into a digital score file transcription, execute one or more simplification instructions on said digital score file transcription, and generate one or more simplified visualization outputs.

In some embodiments, the one more executable instructions further include generating one or more simplified digital score files and then generating said one or more simplified digital score files. The simplification instructions may include at least one of rhythm simplification instructions and harmonic rhythm simplification instructions. They may further include one or more of song length simplification instructions, tempo adjustment simplification instructions, tie simplification instructions, and chord simplification instructions. The visualization may be musical notation related to one or more of melody, chord, lead sheet, or arrangement.

In another embodiment of a computer implemented method of the present invention, the method includes receiving at least one digital score file, one or more inputs related to the plurality of simplification levels, and one or more inputs related to a desired score type of the simplified visualization output. The method may further include execution, by a processor, of one or more song length simplification rules, one or more tempo adjustment rules, one or more tie simplification rules, and at least one of rhythm simplification rules and harmonic rhythm simplification rules. In addition, the method may include generating at least one simplified visualization output.

In some embodiments of such a method, the digital score file may be transcribed prior to executing any of said simplification rules and the simplification rules may be executed on the digital score transcription. The simplification steps may result in generating at least one simplified digital score file, which may then be used to generate the at least one simplified visualization output.

In another embodiment of the invention, a system is provided for transforming a digital score file into one or more of a plurality of levels of simplified visualization outputs. The system includes at least one display device, a non-transitory memory having instructions embedded thereon, and a processor in communication with the non-transitory memory and the at least one display device. The processor is configured to access the instructions to perform or direct steps. The steps performed or directed by the processor may include, but are not limited to, any step described herein. The steps include receiving at least one digital score file, receiving one or more inputs related to the plurality of simplification levels, and executing several rules. The rules include, but are not limited to, song length simplification rules, tempo adjustment simplification rules, tie simplification rules, and rhythm and/or harmonic rhythm simplification rules. The steps further include generating a least one simplified visualization output, which is displayed on the display device.

### BRIEF DESCRIPTION OF THE DRAWINGS

FIG. 1 is a flow chart of a first embodiment of the present invention.

FIG. 2 is a flow chart of a second embodiment of the present invention.

FIG. 3 is table describing tie simplification rules of one or more embodiments of the present invention.

FIG. 4A is a table describing rhythm simplification rules of one or more embodiments of the present invention.

FIG. 4B is a table describing rhythm simplification rules of one or more embodiments of the present invention.

FIG. 4C is a table describing rhythm simplification rules of one or more embodiments of the present invention.

FIG. 4D is a table describing rhythm simplification rules of one or more embodiments of the present invention.

FIG. 4E is a table describing rhythm simplification rules of one or more embodiments of the present invention.

FIG. 5A is a table describing harmonic rhythm simplification rules of one or more embodiments of the present invention.

FIG. 5B is a table describing harmonic rhythm simplification rules of one or more embodiments of the present invention.

FIG. 5C is a table describing harmonic rhythm simplification rules of one or more embodiments of the present invention.

FIG. 5D is a table describing harmonic rhythm simplification rules of one or more embodiments of the present invention.

FIG. 5E is a table describing harmonic rhythm simplification rules of one or more embodiments of the present invention.

FIG. 5F is a table describing harmonic rhythm simplification rules of one or more embodiments of the present invention.

FIG. 5G is a table describing harmonic rhythm simplification rules of one or more embodiments of the present invention.

FIG. 5H is a table describing harmonic rhythm simplification rules of one or more embodiments of the present invention.

FIG. 5I is a table describing harmonic rhythm simplification rules of one or more embodiments of the present invention.

FIG. 6 is a table describing range simplification rules of one or more embodiments of the present invention.

FIG. 7A is a table describing chord simplification rules of one or more embodiments of the present invention.

FIG. 7B is a table describing chord simplification rules of one or more embodiments of the present invention.

FIG. 7C is a table describing chord simplification rules of one or more embodiments of the present invention.

FIG. 7D is a table describing chord simplification rules of one or more embodiments of the present invention.

FIG. 7E is a table describing chord simplification rules of one or more embodiments of the present invention.

FIG. 7F is a table describing chord simplification rules of one or more embodiments of the present invention.

FIG. 7G is a table describing chord simplification rules of one or more embodiments of the present invention.

FIG. 7H is a table describing chord simplification rules of one or more embodiments of the present invention.

FIG. 7I is a table describing chord simplification rules of one or more embodiments of the present invention.

FIG. 7J is a table describing chord simplification rules of one or more embodiments of the present invention.

FIG. 7K is a table describing chord simplification rules of one or more embodiments of the present invention.

FIG. 7L is a table describing chord simplification rules of one or more embodiments of the present invention.

FIG. 8A is an example of visualization output of one or more embodiments of the present invention.

FIG. 8B is an example of visualization output of one or more embodiments of the present invention.

FIG. 8C is an example of visualization output of one or more embodiments of the present invention.

FIG. 8D is an example of visualization output of one or more embodiments of the present invention.

FIG. 9 is an example of a visualization output of a section of an original digital score file and a Level 5 visualization output.

FIG. 10 is an example of the tie simplification visual output in Level 1 of the original digital score file of FIG. 9.

FIG. 11 is an example of the rhythm simplification visualization output in Level 1 of the original digital score file of FIG. 9.

FIG. 12 is an example of the harmonic rhythm simplification visualization output of Level 1 of the original digital score file of FIG. 9.

FIG. 13 is an example of the chord simplification visualization output of Level 1 of the original digital score file of FIG. 9.

FIG. 14 is an example of the simplified notation visualization output of Level 1 of the original digital score file of FIG. 9.

FIG. 15 is an example of tie simplification visualization output in Level 3c of the original digital score file of FIG. 9.

FIG. 16 is an example of the rhythm simplification visualization output in Level 3c of the original digital score file of FIG. 9.

FIG. 17 is an example of the harmonic rhythm simplification visualization output in Level 3c of the original digital score file of FIG. 9.

FIG. 18 is an example of the chord simplification visualization output in Level 3c of the original digital score file of FIG. 9.

### DETAILED DESCRIPTION

Embodiments of the present invention provide a system and method for improving musical education. Methods and systems of the invention use inputs and outputs to transform a digital score file into one or more simplified outputs for users of varying skill levels. This detailed description uses traditional Western music in the preferred and illustrated embodiments; however, the method and system of the present invention is applicable to all types of music. Other types of music to which this invention applies include, but are not limited to, the Carnatic music system, African music systems, and the Arab tone system.

Throughout the detailed description, several figures are referenced that are in chart format with rules inserted therein or with reference numerals inserted therein which are discussed in this detailed description, with the rules based on the level of simplification. In the charts, if a box is left blank, its rule is the rule for the level or level(s) below it for which a rule is presented (either in the chart or via reference numeral).

Certain aspects of Western music will be discussed herein to aid the reader in understanding the invention. As noted above, these aspects of Western music are provided as an example only. Music notation is the combination of musical instructions provided in a visual format to a user. Music notation includes several elements: Notes, which are also called musical notes or pitch, refer to the name assigned to specific musical pitches. For example, in Western music, specific frequencies are equated to letters within the musical alphabet: A, B, C, D, E, F, and G. In addition, in between some of these letters are additional notes notated by a sharp (#) or flat (b) symbol. There are seven letters used in Western music, but 12 notes total. As this invention is applicable to all types of music, including but not limited to Western music, the specific notes provided herein are exemplary only. An octave is a variation of a pitch class. One octave is a multiple of two of a specific frequency. For example, A4=440 Hz, which means that A5=880 Hz and A3=220 Hz.

Pulse refers to a steady, underlying beat that can be played with or against. The rate of a pulse is typically measured by beats per minute (bpm), although the invention is not limited to same. Meter is the measurement of the number of pulses between more or less regularly recurring accents. Tempo is the speed of a song. Tempo may be measured or notated by beats per minute (bpm).

A staff is a set of five lines that act as a matrix for pitch and rhythmic elements. This matrix provides the foundation for visualization of music. Specific notes are assigned to particular places on the staff. Ledger lines are single use lines that allow for differentiation of notes once they are outside of the staff. Also notated on the staff may be one or more rests. A rest is a space or silence in music. In Western music, typically rests have the same structure as a note and can be broken down such as a whole rest, half rest, quarter rest, eighth rest, sixteenth rest, and so on.

The above elements lead to rhythm, which is the systematic arrangement of sounds over time. A sound may include, but is not limited to, a note. With respect to musical rhythm, a hierarchal note system is used, which is subdivided into divisions of two. The largest note is a whole note, which is subdivided into two half notes, which can then be subdivided into four quarter notes, which can then be subdivided into eight eighth notes, which can be subdivided in sixteen sixteenth notes. Further subdivisions occur, but whole, half, quarter, eighth, and sixteenth notes are the most common.

As is known in the art, there are many instruments that exist today, and they all have specific pitch ranges. Because of this, different clefs are used to indicate which notes are represented by the lines and spaces on a musical staff. Placing a clef on a staff assigns a particular pitch to one of the five lines, which defines the pitches on the remaining lines and spaces. Common clefs include, but are not limited to, the treble clef, the bass clef, the alto clef, and the tenor clef. A percussion clef is also used, but it does not set pitches; rather it allows for different drum and percussion instruments to be assigned to each line or space. Sharps and flats may be indicated next to each note, or a particular key may be used to indicate that certain notes are sharp and/or flat throughout an entire piece.

A time signature may be used to specify how many beats are contained in each measure of a piece and which note value is equivalent to a beat. A time signature can be broken down into two components: the top number being how many beats per measure, and the bottom number being what type of note is the pulse or beat. An example may be three over four, wherein there are three (3) quarter notes (4) per measure. While the numerator of a time signature has no real limitations, the denominator is typically a note value, for example, a half note, a quarter note, an eighth note, etc. Time signatures allow for the organization of music into individual measures where one can see starts and ends of phrases, number measures for practice or reference, contextualize rhythms, and interpret how music should be felt.

One of these note values is assigned to the pulse to derive note length. Most commonly the quarter note is assigned to the pulse, meaning that each beat of the pulse is one quarter note. In that case, a quarter note is equal to one beat; a half note is two beats; a whole note is four beats; and an eighth note is one half of a beat; etc. The tempo dictates the speed of the song. In the most common example where quarter notes are assigned to the pulse, the number of beats per minute indicates how many quarter notes occur each minute.

Meter is the measurement of the number of pulses between more or less regularly recurring accents. There are two main types of meter: simple and compound. Simple meter, also called, duple meter, is when each beat is subdivided into two notes. A compound meter, or triple meter, is when each beat is subdivided into three notes.

Notes may be further modified by articulation. As is known in the art, common types of articulation include, but are not limited to: accent, femata, forza, glissando, legato, marcato, porato/mezzo-staccato, rinforzando, sforzando, staccatissimo, staccato, and tenuto.

The dynamics of a piece is the indication or variation in loudness between notes or phrases. Common forms of dynamics include, but are not limited to, crescendo, decrescendo, diminuendo, forte, fortepiano, fortissimo, mezzo forte, mezzo piano, piano, pianissimo. Moreover, music may include expression markings, which indicate how particular music should be played. Expression markings may be directed to a particular section, phrase, or even a single note.

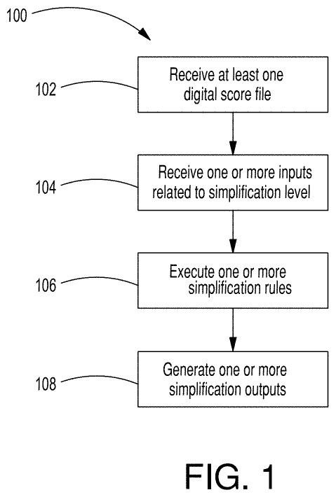

Moving now to the present invention, provided are methods and systems of music simplification. In a first embodiment of a method and system 100 of the invention, steps are provided to transform a digital score file into a simplified visualization for a plurality of skill levels. Referring to FIG. 1, in preferred embodiments, a system first receives at least one digital score file 102. The digital score file may be of any type known in the art, now or in the future. It may be of any length or complexity. In preferred embodiments, the digital score file may be a MIDI file. Next, the system may optionally receive one or more inputs related to the simplification level needed for the output 104. The system may then execute one or more simplification rules 106. The system may then generate one or more simplified outputs 108, preferably including a visualization output. In preferred embodiments, the method is a computer implemented method. Preferred systems of carrying out computer implemented methods of the present invention include a non-transitory memory having instructions embedded thereon and a processor in communication with the non-transitory memory. The processor may be configured to access the instructions to perform or direct the steps of the method discussed herein. In some embodiments, systems of the present invention may also include a display. The processor may also be in communication with the display. In disclosed embodiments, depending on the format of the digital score file, methods and systems of the invention involve one or more transcription steps. It is important to note that the invention applies to simplification scenarios wherein transcription is not required, such as when the digital score file is already in musical notation, such as sheet music, etc. Accordingly, simplification may occur without transcription.

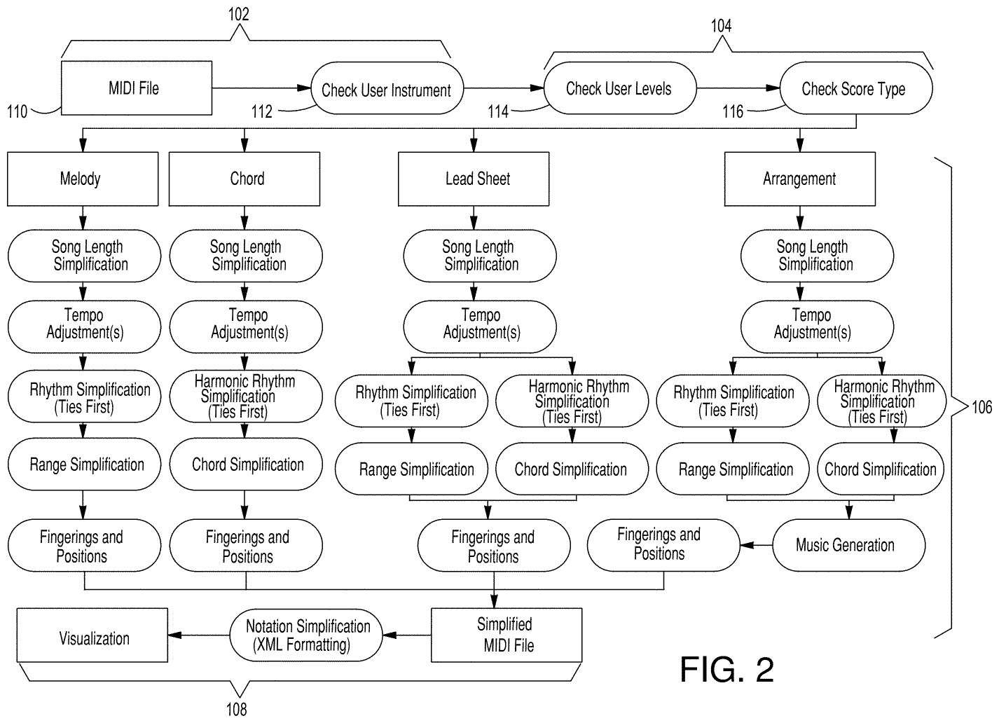

Referring now to FIG. 2, a flow chart of an exemplary preferred embodiment of a method and system of the present invention is shown. This illustrated, preferred embodiment is computer implemented. The method and system of FIG. 2 includes all of the steps shown in FIG. 1, namely, receiving a digital score file 102, receiving one or more inputs related to simplification level 104, executing one or more simplification rules 106, and generating one or more simplified visualization outputs 108. With these steps, the digital score file 102 is transformed into a simplified visual output 180 for a user of any level.

In the preferred embodiment of FIG. 2, the digital score file is a MIDI file 110. The user may use a graphical user interface (GUI) to choose a MIDI file to which the system has access for simplification by the system. Several other steps of the method may also include one or more GUIs for input and/or output of the system, such as entry of inputs and display of one or more simplified visualization outputs. The system also receives one or more inputs related to the simplification level 104. In preferred embodiments, these inputs are used to determine the type and/or amount of simplification needed. The inputs related to simplification level may include, but are not limited to, instrument type, and/or user skill level. Accordingly, the system will check the user instrument 112 and the user level 114. With respect to a user's skill level, the method and system may receive one or more inputs related to skill level. In preferred embodiments, skill level inputs are then used by the system to transform the length, rhythm, chords, and notation of the digital score file. These skill levels may be inputted by a user, saved over time, and/or determined by the system for a particular user based on the user's previous use of the system, such as by machine learning, benchmarking, or other ways. Moreover, the system will check the score type 116. In this step, the system determines what type of output will be generated by the system. The score type 116 may be inputted by a user or it may be saved in the system or automatically determined by the system based on previous use of the system and/or based on an evaluation of the digital score file by the system.

Referring to FIG. 2, the score type inputs may include, but are not limited to, melody 118, chord 120, lead sheet 122, and arrangement 124. As is known in the art, a melody 118 is a sequence of notes that is musically satisfying and is the principal part in harmonized music. A chord 120, on the other hand, is often known as a set of pitches consisting of multiple notes and are used to support the melody 118. Many musical pieces include both melody 118 and chord 120. A lead sheet 122 compacts music into the smallest format possible, typically a one sheet page that provides both melody and harmony parts. Stated another way, a lead sheet is an abbreviated from of musical notation featuring only the essential information. An arrangement 124 is full sheet music including all musical notation including information in addition to the essential information or elements.

Accordingly, before executing the simplification rules, in preferred embodiments, the system checks the user instrument 112, the user level 114, and the score type 116 desired. As noted above, these inputs may be from a user or any other means. Depending on the score type 116, the system may execute one or more of four series of simplification rules. First, the melody 118 simplification rules may be executed to generate a simplified melody visualization. Next, the chord 120 simplification rules may be executed to generate a simplified chord visualization. Third, the lead sheet 122 rules may be executed to generate a simplified lead sheet visualization. Because the lead sheet 112 includes both melody and chord elements, one or more portions of the lead sheet 122 simplification rules may include the melody and/or chord simplification rules. In the preferred embodiment, the fourth option is arrangement 124 simplification rules which may be executed to provide arrangement sheet music.

After the system has received inputs related to simplification level 104, the system is ready to execute one or more simplification rules 106. If the score type is melody, in preferred embodiments, only the melody simplification rules will be executed. The execution of the melody simplification rules 118 may include one or more series of rules, including but not limited to song length simplification 126, tempo adjustment(s) 128, rhythm simplification 130 (preferably with ties first), range simplification 132, and/or fingerings and positions 134. All of these series of rules will be discussed in further detail below. After all melody 118 simplification rules 126, 128, 130, 132, 134 are executed, the system will generate a simplified MIDI file 176.

Alternatively, the score type may be chord 120, in which case a series of chord simplification rules are executed. Execution of the chord simplification rules 120 may include one or more series of rules, including but not limited to, song length simplification 136, tempo adjustments(s) 138, harmonic rhythm simplification (preferably with ties first) 140, chord simplification 142, and/or fingerings and positions 144. All of these series of rules will be discussed in further detail below. After all chord 120 simplification rules 136, 138, 140, 142, 144 are executed, the system will generate a simplified MIDI file 176.

Still referring to FIG. 2, the execution of the lead sheet simplification rules may include one or more series of rules, including but not limited to, song length simplification 146, tempo adjustment(s) 148, rhythm simplification (preferably with ties first) 150, range simplification 152, harmonic rhythm simplification 154, chord simplification 156, and/or fingers & positions 158. Because a lead sheet generally includes material related to both melody and harmony, elements of the melody 118 and harmony 120 simplification rules may be present in the lead sheet 122 simplification rules. After all lead sheet 122 simplification rules 144, 146, 148, 150, 152, 154, 156, 158 are executed, the system will generate a simplified MIDI file 176.

Execution of the arrangement simplification 124 may include, but is not limited to song length simplification 160, tempo adjustment(s) 162, rhythm simplification (preferably with ties first) 164, range simplification 166, harmonic rhythm simplification 168, chord simplification 170, music generation 172, and/or fingers & positions 174. Because an arrangement generally includes all musical notation, elements of melody and chords are typically present. As such, the arrangement 124 simplification rules may include elements of the melody 118 and chord 120 simplification rules. In addition, the arrangement 124 simplification rules may include elements of the lead sheet 122 simplification rules, as the elements of a lead sheet are typically found on an arrangement. After all arrangement 124 simplification rules 160, 162, 164, 166, 168, 170, 172, 174 are executed, the system will generate a simplified MIDI file 176.

In preferred embodiments, the simplification rules generate a simplified digital score, which in the illustrated preferred embodiment is a simplified MIDI file 176. The system then generates notation simplification 178, which may be XML formatting in the preferred embodiment. The method and system then provide a visualization 180 of the simplified digital score to the user. The visualization 180 may be a transcription of the simplified digital score file. Accordingly, the result of the process is to transform the original digital score 102 file into a simplified visualization 108 for the user. The simplified visualization 108 is tailored to the skill level of the user.

In preferred embodiments, the simplification results in four primary levels of simplification, although some levels may be further subdivided. The four primary levels result from the length of the simplification, which will be discussed below. However, one of skill in the art will recognize that any number of simplification levels and sublevels may be employed.

Referring to FIG. 2, all categories of execution of the simplification rules begin with song length simplification. In the preferred embodiment, all song length simplification noted on FIG. 2, namely 126, 136, 146, 160 follow the same rules. With respect to the song length simplification rules, the preferred levels are as follows (with level 1 being the most beginner and higher levels being more advanced): (1) Level 1—the length of the output is the shortest and is preferably limited to the section that has been repeated in the digital score file the most, for example a chorus. If the section that is repeated the most is tied to another section, the system will choose the section that comes first. (2) Level 2—the length of the output is two sections—the section of Level 1 plus the next most repeated section. (3) Level 3—the length of approximately half of the digital score file, ending at the end of a section. (4) Level 4—the full digital score file. In preferred embodiments, the method and system include a transcription step. Once a song is transcribed, the system be configured to mark sections based on how similar they are to each other. The length of the output can then be generated based on rules, such as the preferred rules discussed herein above. Table 1 below provides this information in tabular form. With respect to Level 2, the rules may be configured to choose any section of the song for the second song. In preferred embodiments, however, the second section is the second most repeated section.

TABLE 1
Song length simplification rules of the preferred
embodiment of a system and method of the invention.

| | |
|---|---|
| Level 4 (hardest) | Full track |
| Level 3 | Half of the track. (For example, introduction, ABAB) |
| Level 2 | Two sections (For example, AB) |
| Level 1 (easiest) | One section, preferably the section that has been |
| | repeated the most. (If tied with another section, |
| | preferred methods and systems choose the section |
| | that comes first.) |

Referring to FIG. 2, all categories of execution also include tempo adjustments. In preferred embodiments, tempo-based simplification adjustment rules are employed to carry out the tempo adjustment(s). In the embodiment disclosed in FIG. 2, all tempo adjustment steps 128, 138, 148, 162 follow the same simplification rules. Tempo-based simplification adjustment rules of the preferred embodiment are found in Table 2 below. In the rules, the tempo remains the same as the original digital score file 102 throughout all simplification levels. However, the system will adjust the level of rhythm simplification (the rules of which are discussed in detail below) up or down one or more levels. As will be recognized by one of skill in the art, a higher or faster tempo can result in making a piece harder to play. On the other hand, a lower or slower tempo can result in making a piece easier to play. In the preferred embodiment of the method and system of the present invention, the tempo is not adjusted. The tempo remains the same as the original digital score file 102. However, the rhythm simplification is preferably adjusted to compensate for the difficulty or ease provided by the tempo. The rhythm simplification will be discussed in further detail below. Table 2 describes how the levels of rhythm simplification are preferably adjusted to compensate for the tempo. For example, looking at Level 2a, if the tempo is 160 bpm-200+bpm, then the rhythm simplification is adjusted downward two levels, so it would be at the typical Level la output. However the tempo would be quite fast, which would provide difficulty. On the other hand, looking at Level 2a when the tempo is 40 bpm-80 bpm, the rhythm simplification would be adjusted up one level. Accordingly, the level 3a rhythm simplification would be used in the output. The rhythm would be more difficult, but the slow tempo would compensate for the increased difficulty.

TABLE 2
Tempo adjustment rules of the preferred embodiment
of a system and method of the invention.

| Tempo Range | >40 bpm-80 bpm | 80 bpm-120 bpm | 120 bpm-160 bpm | 160 bpm-200+ bpm |
|---|---|---|---|---|
| Level 5 | Original level | Original level | Original level | Original level |
| Level 4c | Original level | Original level | Original level | −1 Level |
| Level 4b | Original level | Original level | Original level | −2 Level |
| Level 4a | +1 Level | Original level | Original level | −1 Level |
| Level 3d | Original level | Original level | Original level | −1 Level |
| Level 3c | +1 Level | Original level | −1 Level | −2 Level |
| Level 3b | +1 Level | Original level | Original level | −1 Level |
| Level 3a | Original level | Original level | −1 Level | −2 Level |
| Level 2b | +1 Level | Original level | Original level | −1 Level |
| Level 2a | +1 Level | Original level | −1 Level | −2 Level |
| Level 1b | Original level | Original level | Original level | Original level |
| Level 1a | Original level | Original level | Original level | Original level |

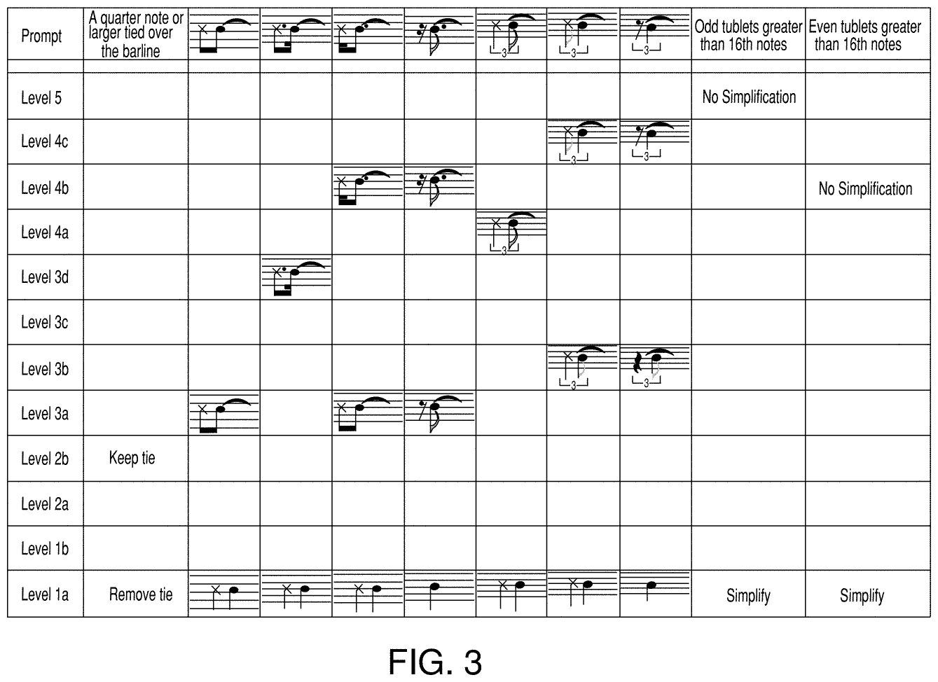

As noted above, the system and method may include rules related to tied notes, such as in the rhythm and harmonic rhythm simplification series of simplification rules. See for example FIG. 2, reference numerals 130, 140, 150, 154, 164, and 168. Referring to FIG. 3, the preferred embodiment of rules for the simplification of tied notes is provided via tie simplification rules. As is known in the art, a tied note is a note meeting the following definition: either (1) a note that starts after a downbeat and its length extends past its beat and/or (2) a note whose length extends past its measure. The rules result in output wherein the tie is removed completely in more beginner levels to, in the harder levels, no simplification being required. In the preferred tie simplification rules, the output is determined based on which side of the halfway point the tied note falls on. In the first option, tied notes that fall before an eighth note (0.5) will simplify backwards to the downbeat. In the second option, tied notes that fall on or after an eighth note will simplify forwards to the next downbeat. In a third option, if the note is a quarter note or larger tied over the barline, the simplification rules remove the tie and create two or more separate notes. With respect to the order of the tie simplification rules, in preferred embodiments, the simplification method and system begin with notes smaller than a quarter note first. The method and system proceed beat by beat backwards from the end of a measure to the beginning. If the case of first option tied notes that cannot move back, such as because a note exists on its downbeat, the note is moved to the nearest subdivision after the halfway point (0.5). As is known in the art, one type of subdivision is a tuplet. A tuplet and subdivision are used herein interchangeably. Accordingly, in figures where the term “tuplet” is used, “subdivision” could also be used interchangeably. Next, tied notes that are a quarter note are simplified in the same way, followed by notes larger than a quarter note, preferably in order of length. Once all ties are simplified, the measure then goes through the remainder of the simplification method and system.

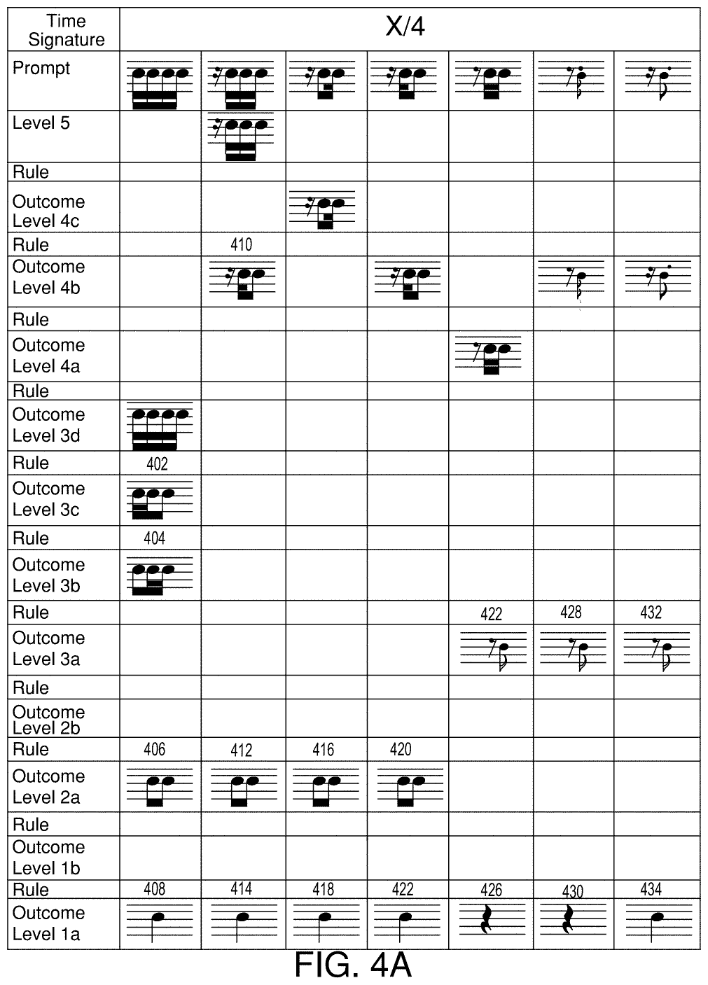

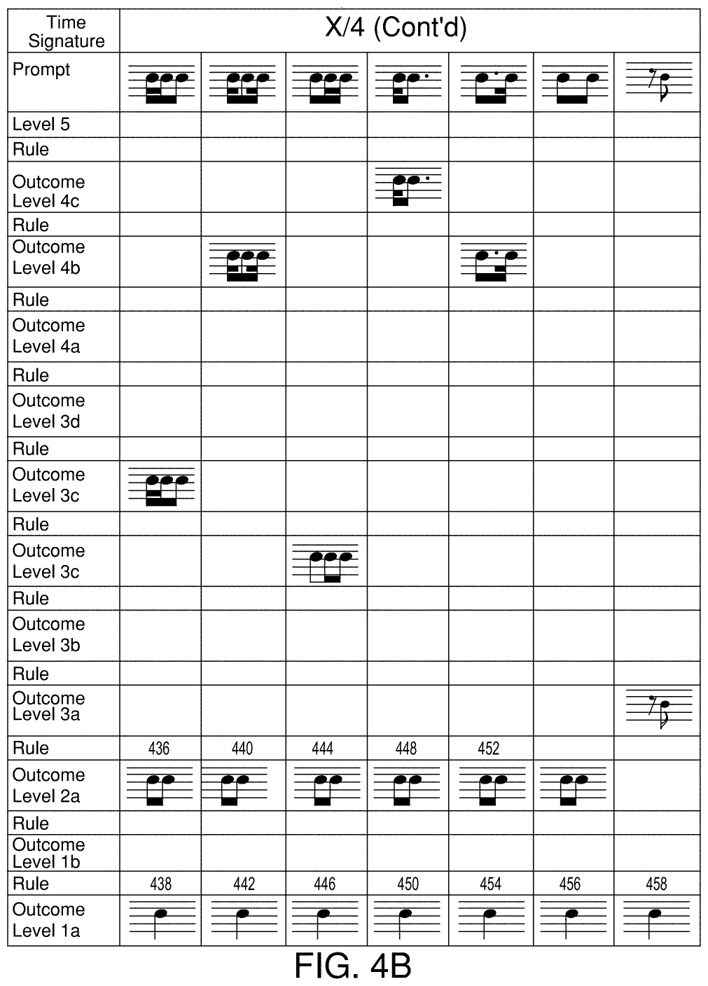

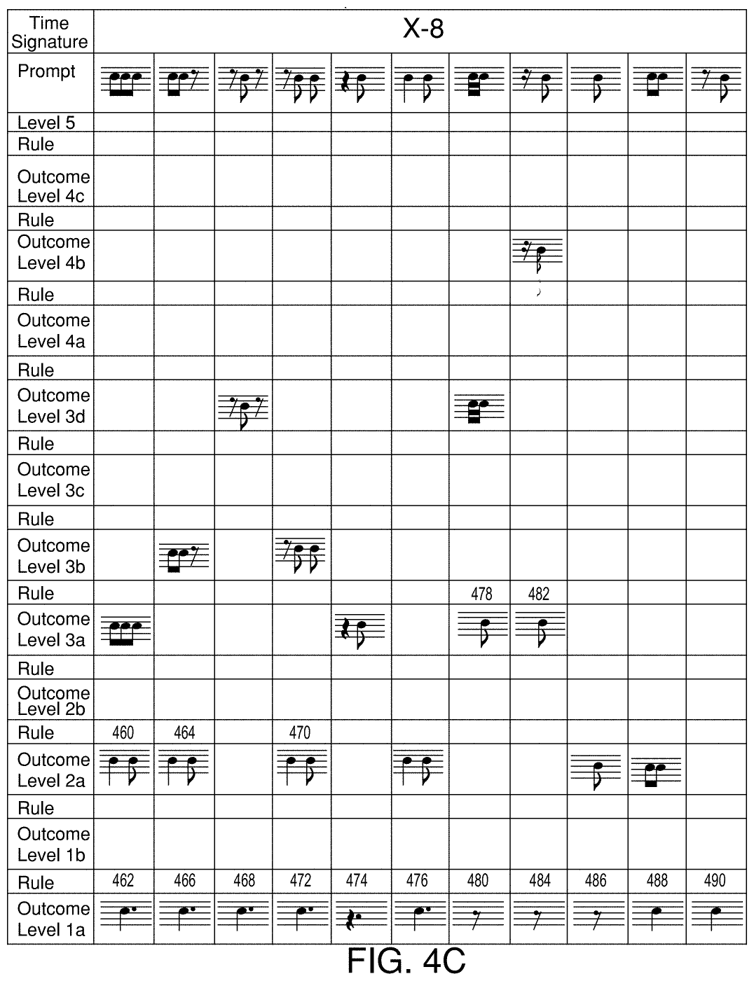

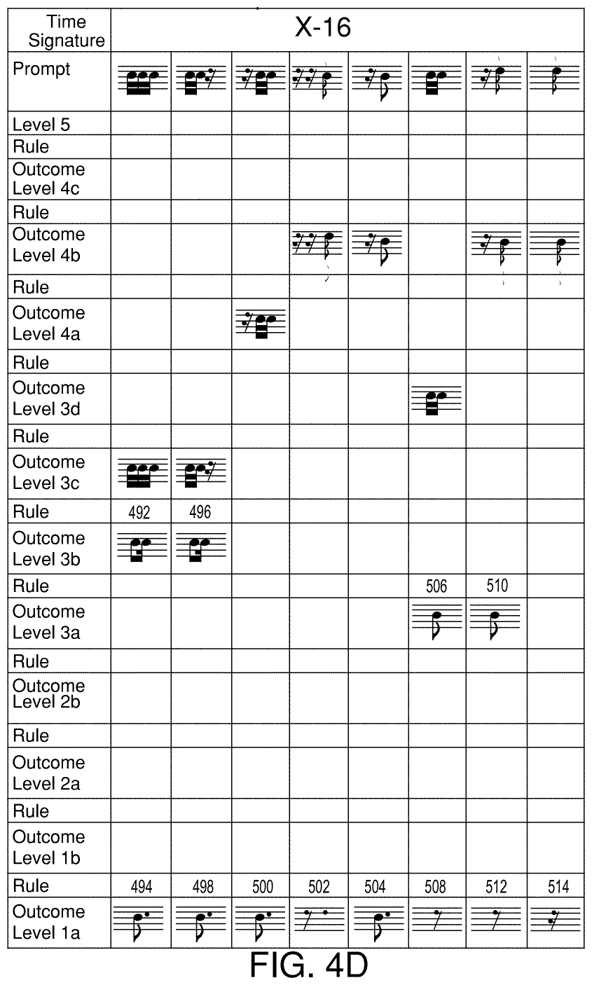

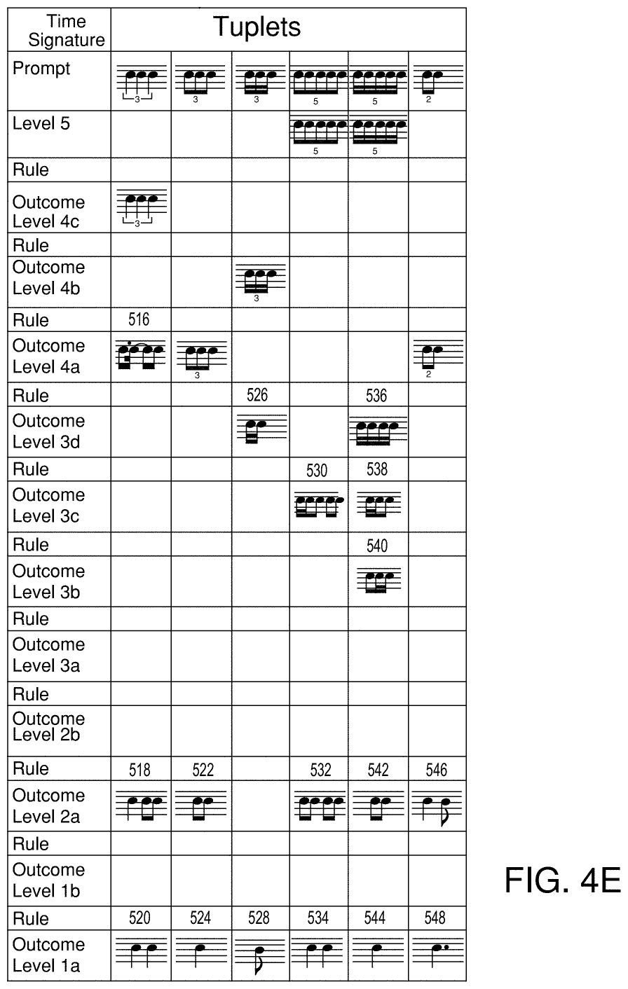

Referring again to FIG. 2, in preferred embodiments after the song length, tempo, and ties are simplified, rhythm and/or harmonic rhythm simplification may occur via rhythm simplification rules and harmonic rhythm simplification rules, respectively. If the score type is melody 118, then rhythm simplification 130 occurs. If the score type is chord, then harmonic rhythm simplification occurs 140. In the case of lead sheet 122 or arrangement 124 score types, both rhythm simplification 150, 164 and harmonic rhythm simplification 154, 168 may occur. As noted above, rhythm relates to the timing of the specific notated music notes. Harmonic rhythm refers to the rhythm of the chords or harmonies that contextualize the music notes. Rhythmic simplification is accomplished by simplifying beat by beat within the measure. By matching the expressed rhythm within each beat to one in the simplification rules, there is a clear path for how each rhythm should be simplified. The simplified rhythms prioritize the strong beats of each rhythm (quarter notes, then eighth notes, then sixteenth notes, etc.) so the integrity and key notes of a passage is preserved. Because each beat in a measure is checked, it is important to have the full spectrum of note groupings and in which time signature those groupings would appear in. For that reason, the rhythm simplification chart (Table 3) is organized by the denominator of time signatures, as that has influence over the grouping of notes. FIGS. 4A-4E show the preferred embodiment of the rhythm simplification rules. Furthermore, Table 3 below is a key to the reference numerals in FIGS. 4A-4E.

TABLE 3
Key to rules designated by reference numerals in FIGS. 4A-4E.

| | FIG. 4A |
|---|---|
| 410 | Delete third note, second note becomes 8^{th} note |
| 402 | Delete fourth note, third note becomes 8^{th} note |
| 404 | Delete second note, first note becomes 8^{th} note |
| 422 | Delete second note, turn first note into 8^{th} note |
| 428 | Move note one 16^{th} back, turn into 8^{th} note |
| 432 | Move note one 16^{th} forward, turn into 8^{th} note |
| 406 | Delete second and fourth note, turn first and third into 8^{th} notes |
| 412 | Move all three notes one 16^{th} back, delete second note, turn first and third note into 8^{th} notes |
| 416 | Move both notes one 16^{th} back, turn both notes into 8 notes |
| 420 | Move first note one 16^{th} back, turn first note into 8^{th} note |
| 408 | Delete second, third and fourth notes, turn first note into quarter note |
| 414 | Delete second and third note, move first note one 16^{th} back, turn first note into quarter note |
| 418 | Delete second note, move first note one 16^{th} back, turn first note into quarter note |
| 422 | Delete second note, move first note one 16^{th} back, turn first note into quarter note |
| 426 | Delete note |
| 430 | Delete note |
| 434 | Move note one 16^{th} back, turn into quarter note |
| | FIG. 4B |
| 436 | Delete second note, turn first note into 8^{th} note |
| 440 | Delete first note, move second and third note one 16^{th} back and turn them into 8^{th} notes |
| 444 | Delete third note, turn second note into 8^{th} note |
| 448 | Move second note one 16^{th} forward, turn both notes into 8^{th} notes |
| 452 | Move second note one 16^{th} back, turn both notes into 8^{th} notes |
| 438 | Delete second and third note, turn first note into quarter note |
| 442 | Delete first and third note, move second note one 16^{th} back and turn into quarter note |
| 446 | Delete second and third note, turn first note into quarter note |
| 450 | Delete second note, turn first note into quarter note |
| 454 | Delete second note, turn first note into quarter note |
| 456 | Delete second note, turn first note into quarter note |
| 458 | Move note one 8^{th} note back, turn into quarter note |
| | FIG. 4C |
| 460 | Delete middle note, turn first note into quarter note |
| 462 | Delete second and third note, turn first note into dotted quarter note |
| 464 | Move second note one 8^{th} forward, turn first note into quarter note |
| 466 | Delete second note, turn first note into dotted quarter note |
| 468 | Move second note one 8^{th} back, turn first note into doted quarter note |
| 470 | Move first note one 8^{th} back, turn first note into quarter note |
| 472 | Delete second note, move first note one 8^{th} back, turn into doted quarter note |
| 474 | Delete note |
| 476 | Delete second note, turn first note into dotted quarter note |
| 478 | Delete second note, turn first note into 8^{th} note |
| 480 | Delete note |
| 482 | Move note one 16^{th} back, turn into 8^{th} note |
| 484 | Delete note |
| 486 | Delete note |
| 488 | Delete second note, turn first note into quarter note |
| 490 | Move note one 8^{th} note back, turn into quarter note |
| | FIG. 4D |
| 492 | Delete middle note, turn first note into 8^{th} note |
| 494 | Delete second and third note, turn first note into dotted 8^{th} note |
| 496 | Move second note one 16^{th} forward, turn first note into 8^{th} note |
| 498 | Delete second note, turn first note into dotted 8^{th} note |
| 500 | Delete second note, move first note back one 16^{th}' turn note into dotted 8^{th} note |
| 502 | Delete note |
| 504 | Move first note back one 16^{th}, turn note into dotted 8^{th} note |
| 506 | Delete second note, turn first note into 8^{th} note |
| 508 | Delete note |
| 510 | Move note one 16^{th} back, turn into 8^{th} note |
| 512 | Delete note |
| 514 | Delete note |
| | FIG. 4E |
| 516 | Turn first note into dotted 8th note, turn second note into 16th note placed on fourth 16th |
| | position tied to 8th note, turn third note into 8^{th} note in second 8^{th} position of second beat |
| 518 | Turn first note into quarter note, turn second and third note into 8^{th} notes on second beat |
| 520 | Delete second note, turn first and third note into two quarter notes |
| 522 | Delete second note, turn first and third note into two 8^{th} notes |
| 524 | Delete second and third note, turn first note into quarter note |
| 526 | Delete second note, turn first and third note into two 16^{th} notes |
| 528 | Delete second and third note, turn first note into eighth note |
| 530 | Turn first and second notes into two 16ths on first beat, turn third note into 8^{th} note in |
| | second 8^{th} position of first beat, turn fourth and fifth note into 8^{th} notes of second beat |
| 532 | Delete last note, turn first, second, third, and fourth notes into 8^{th} notes |
| 534 | Delete second, fourth, and fifth notes, turn first and third note into quarter notes |
| 536 | Delete last note, turn first, second, third, and fourth notes into 16^{th} notes |
| 538 | Delete fourth and fifth note, turn first and second note into 16^{th} notes, turn third note |
| | into 8^{th} in second 8^{th} position of first beat |
| 540 | Delete second and third note, turn first note into 8^{th} note, turn fourth and fifth note |
| | into 16ths in third and fourth 16^{th} position of first beat |
| 542 | Delete second, fourth, and fifth notes, turn first and third note into 8^{th} notes |
| 544 | Delete second, third, fourth, and fifth note, turn first note into quarter note |
| 546 | Turn first note into quarter note, turn second note into 8^{th} note in third 8^{th} position |
| 548 | Delete second note, turn first note into dotted quarter note |

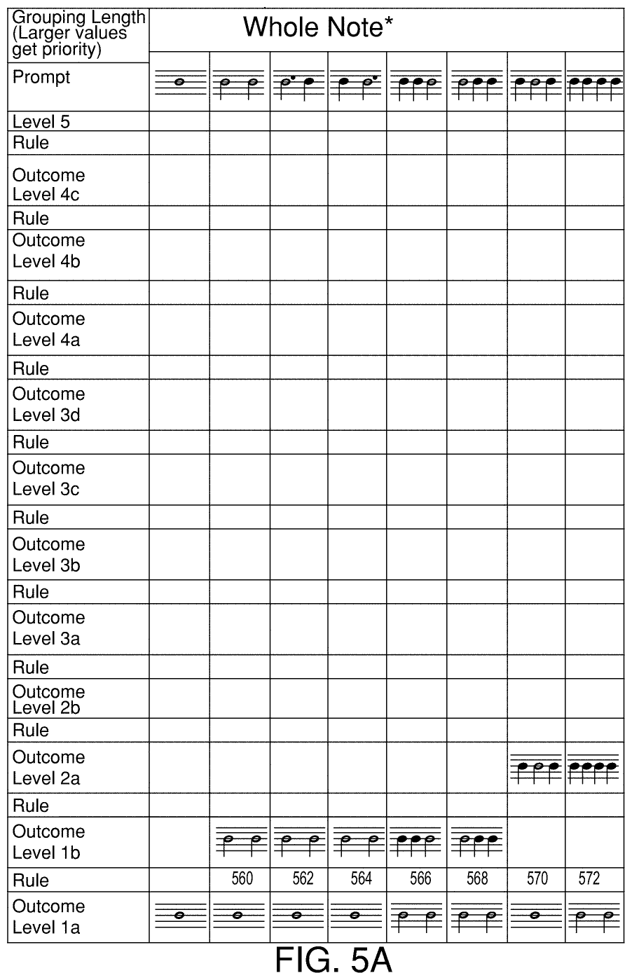

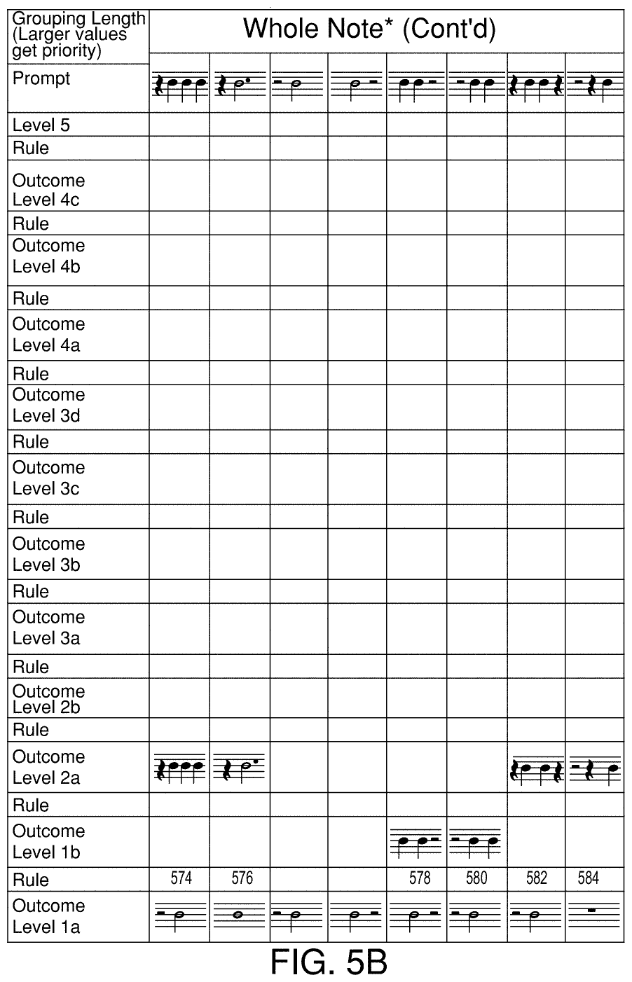

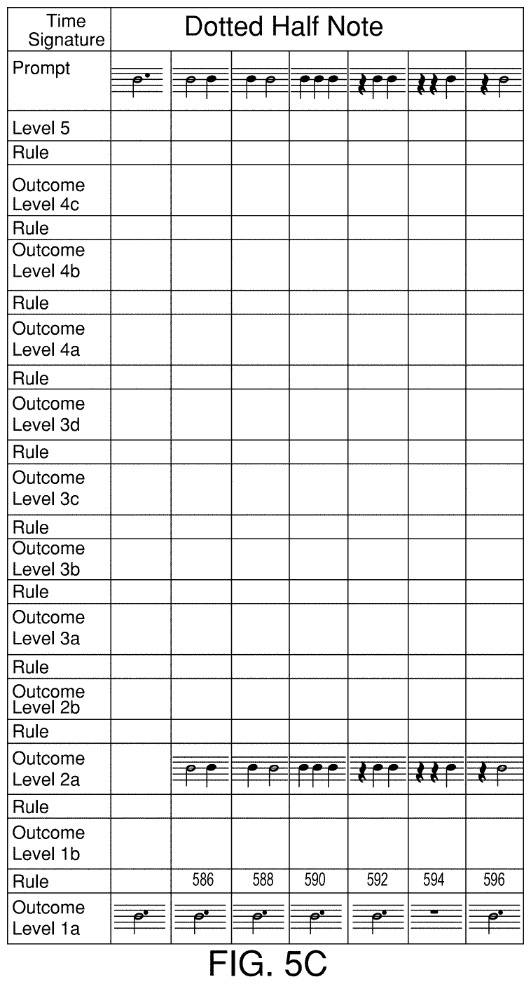

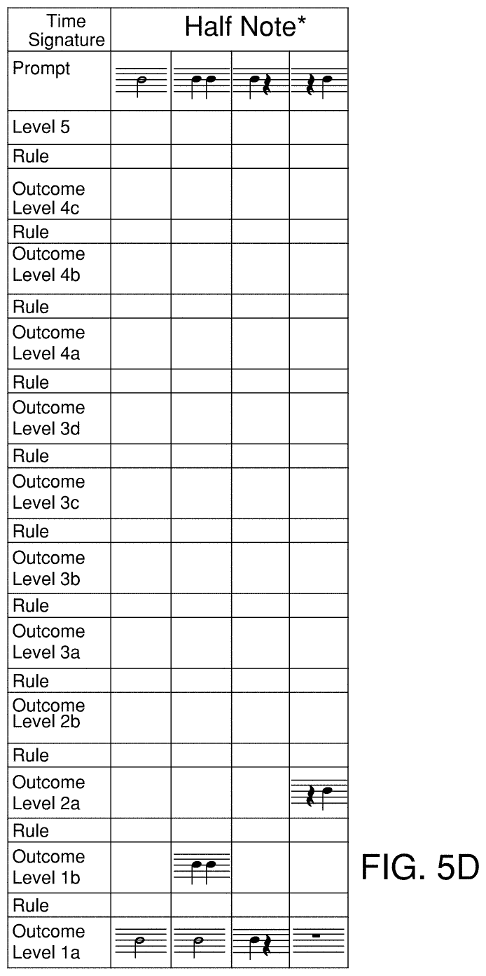

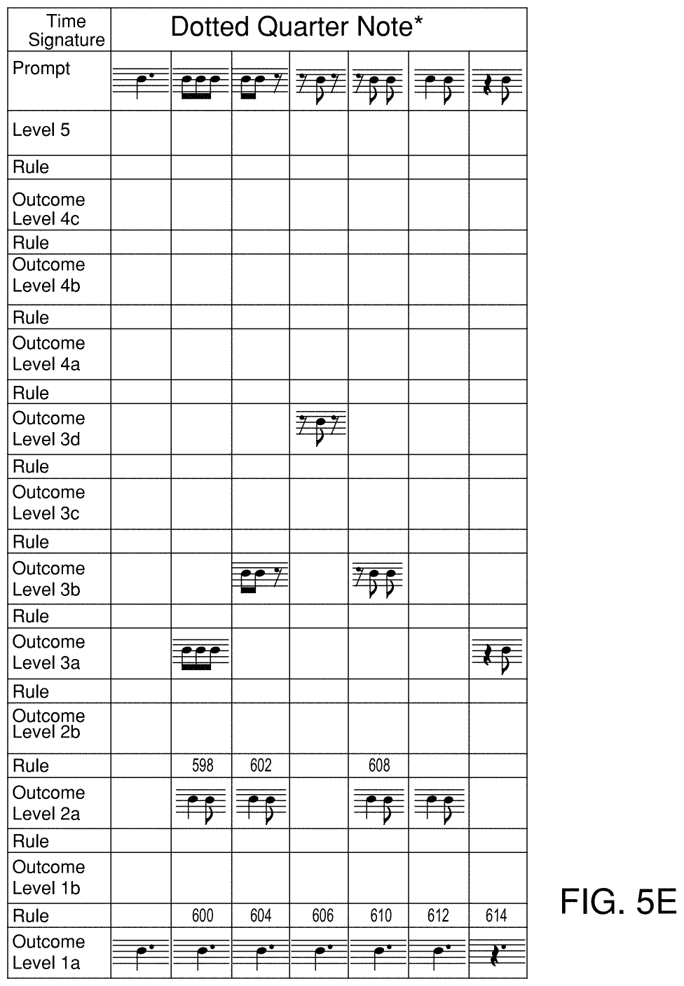

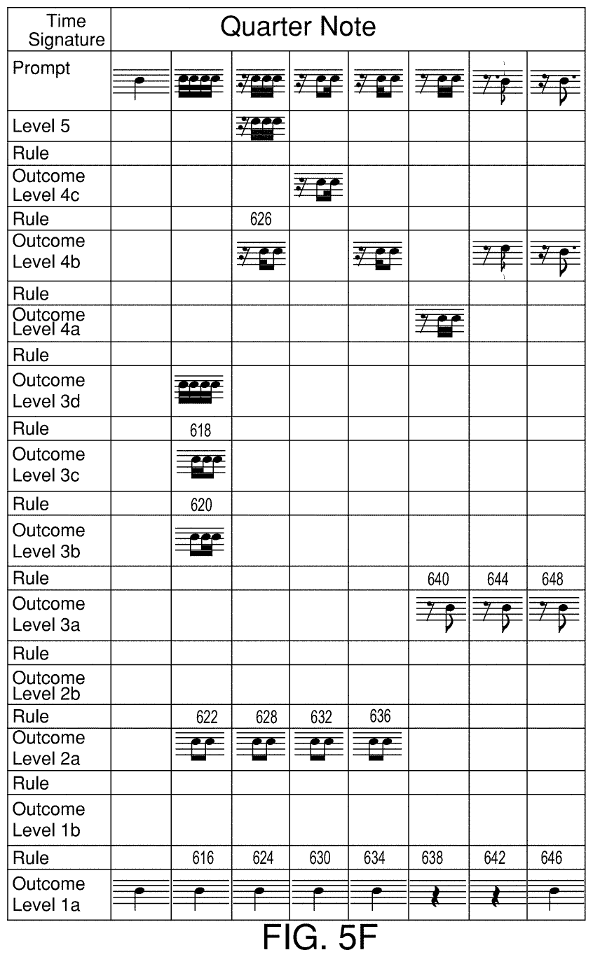

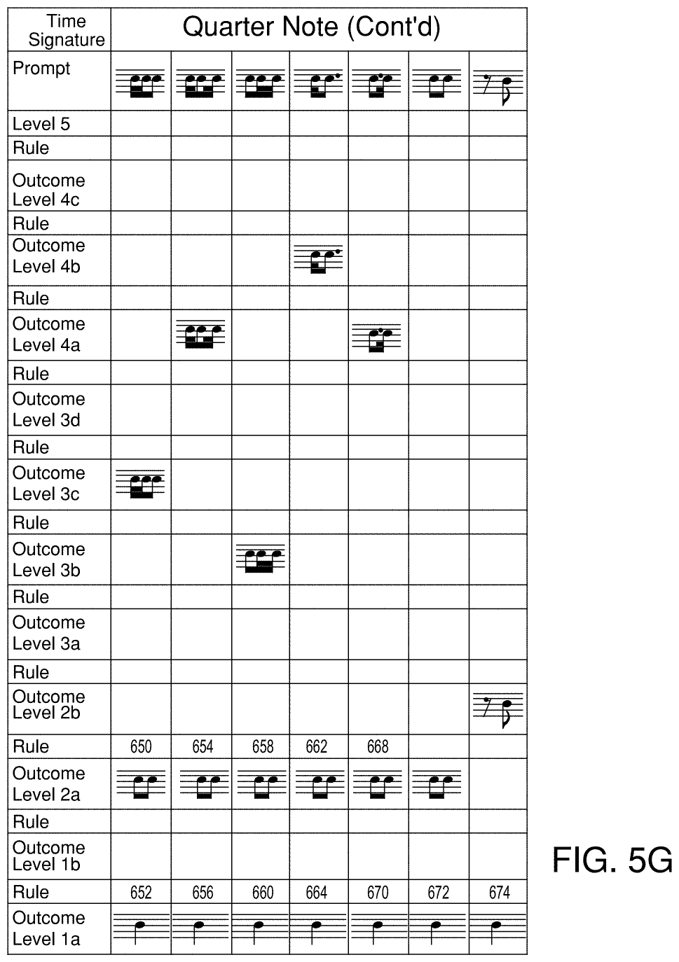

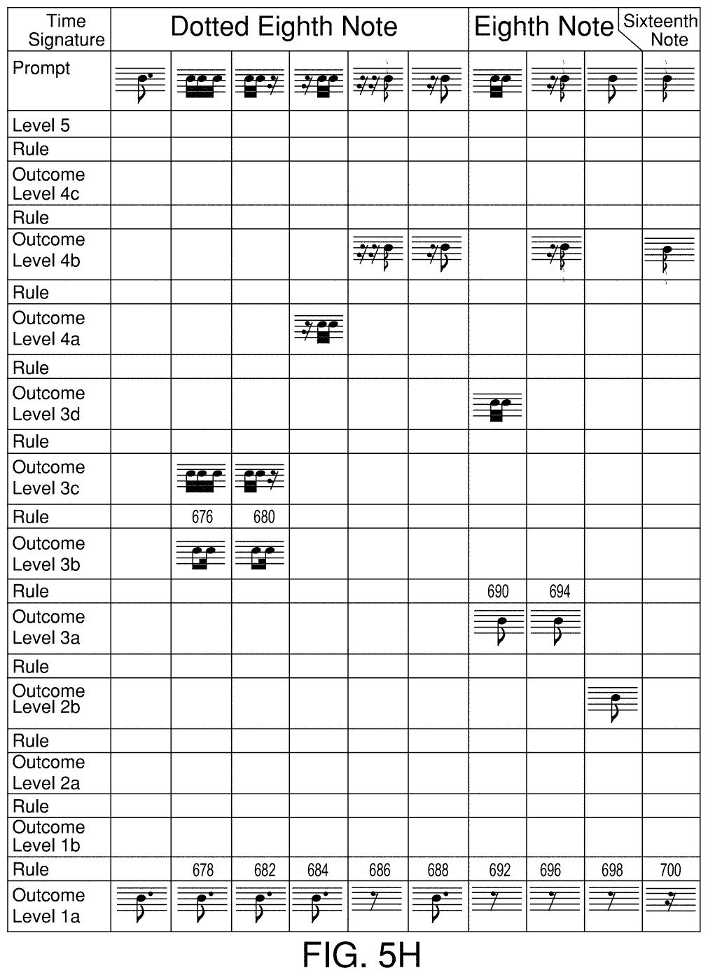

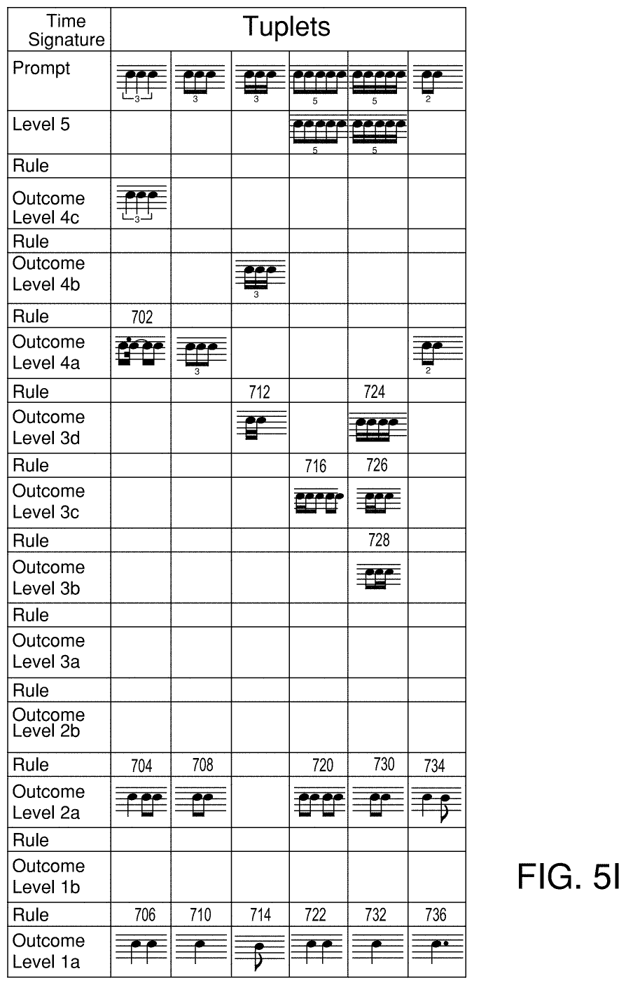

The harmonic rhythm simplification rules of the preferred embodiment depend on the grouping length, such as a whole note, dotted half note, half note, dotted quarter note, quarter note, dotted eighth note eighth note, sixteenth note, and tuplets. FIGS. 5A-5I show the preferred embodiment of the harmonic rhythm simplification rules. Furthermore, Table 4 below is a key to the reference numerals in FIGS. 5A-5I.

TABLE 4
Key to rules designated by reference numerals in FIGS. 5A-5I.

| | FIG. 5A |
|---|---|
| 560 | Delete second note, turn first note into whole note |
| 562 | Delete second note, turn first note into whole note |
| 564 | Delete first note, turn second note into whole note |
| 566 | Delete second note, turn first note into half note |
| 568 | Delete fourth note, turn third note into half note |
| 570 | Delete first and fourth note, move second note back a quarter note, turn note into whole note |
| 572 | Delete second and fourth note, turn first and third notes into half notes |
| | FIG. 5B |
| 574 | Delete first and third note, turn second note into half note |
| 576 | Move note back one quarter note, turn into whole note |
| 578 | Delete second note, turn first note into half note |
| 580 | Delete second note, turn first note into half note |
| 582 | Delete first note, turn second note into half note |
| 584 | Delete note |
| | FIG. 5C |
| 586 | Delete second note, turn first note into dotted half note |
| 588 | Delete first note, turn second note into dotted half note |
| 590 | Delete second and third note, turn first note into dotted half note |
| 592 | Delete second note, move first note back one quarter note, turn note into dotted half note |
| 594 | Delete note |
| 596 | Move note back one quarter note, bum into dotted half note |
| | FIG. 5E |
| 598 | Delete middle note, turn first note into quarter note |
| 602 | Move second note one 8^{th} forward, turn first note into quarter note |
| 608 | Move first note one 8^{th} back, turn first note into quarter note |
| 600 | Delete second and third note, turn first note into dotted quarter note |
| 604 | Delete second note, turn first note into dotted quarter note |
| 606 | Move second note one 8^{th} back, turn first note into dotted quarter note |
| 610 | Delete second note, move first note one 8^{th} back, turn into dotted quarter note |
| 612 | Delete second note, turn first note into dotted quarter note |
| 614 | Delete note |
| | FIG. 5F |
| 616 | delete second, third, and fourth notes, turn first note into quarter note |
| 618 | Delete fourth note, third note becomes 8^{th} note |
| 620 | Delete second note, first note becomes 8^{th} note |
| 622 | Delete second and fourth note, turn first and third into 8^{th} notes |
| 624 | Delete second and third note, move first note one 16^{th} back, turn first note into quarter note |
| 626 | Delete third note, second note becomes 8^{th} note |
| 628 | Move all three notes one 16^{th} back, delete second note, burn first and third note into 8^{th} notes |
| 630 | Delete second note, move first note one 16^{th} back, turn first note into quarter note |
| 632 | Move both notes one 16^{th} back, turn both notes into 8^{th} notes |
| 634 | Delete second note, move first note one 16^{th} back, turn first note into quarter note |
| 636 | Move first note one 16^{th} back, turn first note into 8^{th} note |
| 638 | Delete note |
| 640 | Delete second note, turn first note into 8^{th} note |
| 642 | Delete note |
| 644 | Move note one 16^{th} back, turn into 8^{th} note |
| 646 | Move note one 16^{th} back, turn into quarter note |
| 648 | Move note one 16^{th} forward, turn into 8^{th} note |
| | FIG. 5G |
| 650 | Delete second note, turn first note into 8^{th} note |
| 652 | Delete second and third note, turn first note into quarter note |
| 654 | Delete first note, move second and third note one 16^{th} back and turn them into 8^{th} notes |
| 656 | Delete first and third note, move second note one 16^{th} back and turn into quarter note |
| 658 | Delete third note, turn second note into 8^{th} note |
| 660 | Delete second and third note, turn first note into quarter note |
| 662 | Move second note one 16^{th} forward, turn both notes into 8^{th} notes |
| 664 | Delete second note, turn first note into quarter note |
| 668 | Move second note one 16^{th} back, turn both notes into 8^{th} notes |
| 670 | Delete second note, turn first note into quarter note |
| 672 | Delete second note, turn first note into quarter note |
| 674 | Move note one 8^{th} note back, turn into quarter note |
| | FIG. 5H |
| 676 | Delete middle note, turn first note into 8^{th} note |
| 678 | Delete second and third note, turn first note into dotted 8^{th} note |
| 680 | Move second note one 16^{th} forward, turn first note into 8^{th} note |
| 682 | Delete second note, turn first note into doted 8^{th} note |
| 684 | Delete second note, move first note back one 16^{th}, turn note into doted 8^{th} note |
| 686 | Delete note |
| 688 | Move first note back one 16^{th}, turn note into dotted 8^{th} note |
| 690 | Delete second note, turn first note into 8^{th} note |
| 692 | Delete note |
| 694 | Move note one 16^{th} back, turn into 8^{th} note |
| 696 | Delete note |
| 698 | Delete note |
| 700 | Delete note |
| | FIG. 5I |
| 702 | Turn first note into dotted 8^{th} note, turn second note into 165^{th} note placed on fourth 16^{th} |
| | position tied to 8^{th} note, turn |
| 704 | Turn first note into quarter note, turn second and third note into 8^{th} notes on second beat |
| 706 | Delete second note, turn first and third note into two quarter notes |
| 708 | Delete second note, turn first and third note into two 8^{th} notes |
| 710 | Delete second and third note, turn first note into quarter note |
| 712 | Delete second note, turn first and third note into two 16^{th} notes |
| 714 | Delete second and third note, turn first note into eighth note |
| 716 | Turn first and second notes into two 16ths on first beat, turn third note into 8^{th} note in |
| | second 8^{th} position |
| 720 | Delete last note, turn first, second, third, and fourth notes into 8^{th} notes |
| 722 | Delete second, fourth, and fifth notes, turn first and third note into quarter notes |
| 724 | Delete last note, turn first, second, third, and fourth notes into 16^{th} notes |
| 726 | Delete fourth and fifth note, turn first and second note into 16^{th} notes, turn third note |
| | into 8^{th} in second 8^{th} position |
| 728 | Delete second and third note, turn first note into 8^{th} note, turn fourth and fifth note |
| | into 16^{th} in third and fourth 16th |
| 730 | Delete second, fourth, and fifth notes, turn first and third note into 8^{th} notes |
| 732 | Delete second, third, fourth, and fifth note, turn first note into quarter note |
| 734 | Turn first note into quarter note, turn second note into 8^{th} note in third 8^{th} position |
| 736 | Delete second note, turn first note into dotted quarter note |

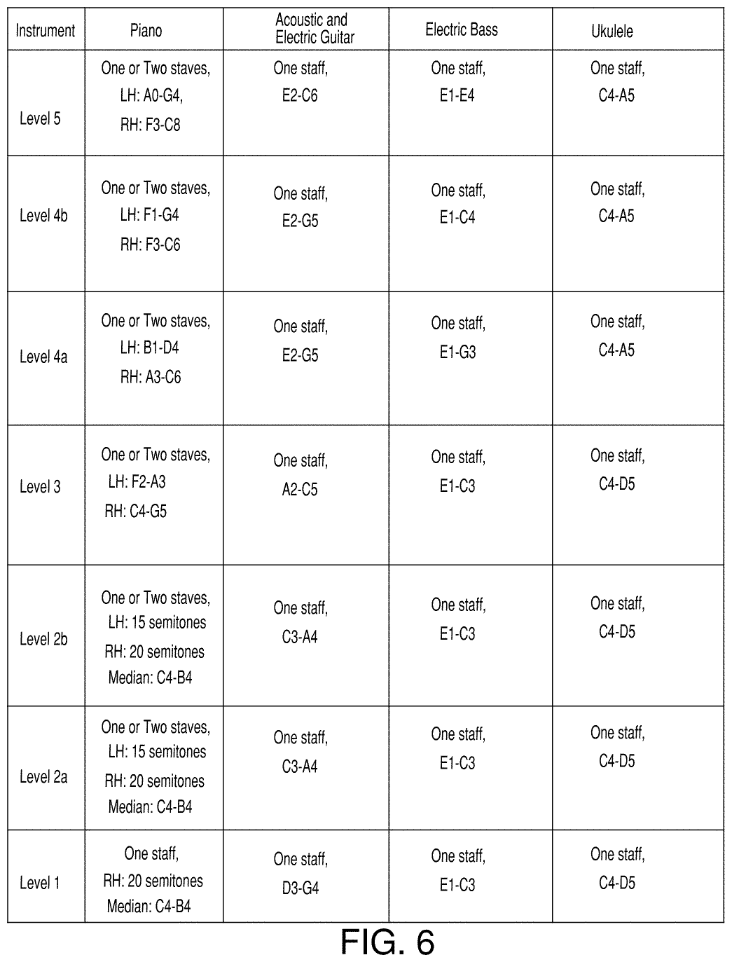

The simplification rules executed by the system may also include range simplification rules, 132, 152, 164. The range simplification rules of the preferred embodiment are shown in FIG. 6. The range simplification rules are aimed at simplifying the range of notes, or musical pitches, that are present in the score.

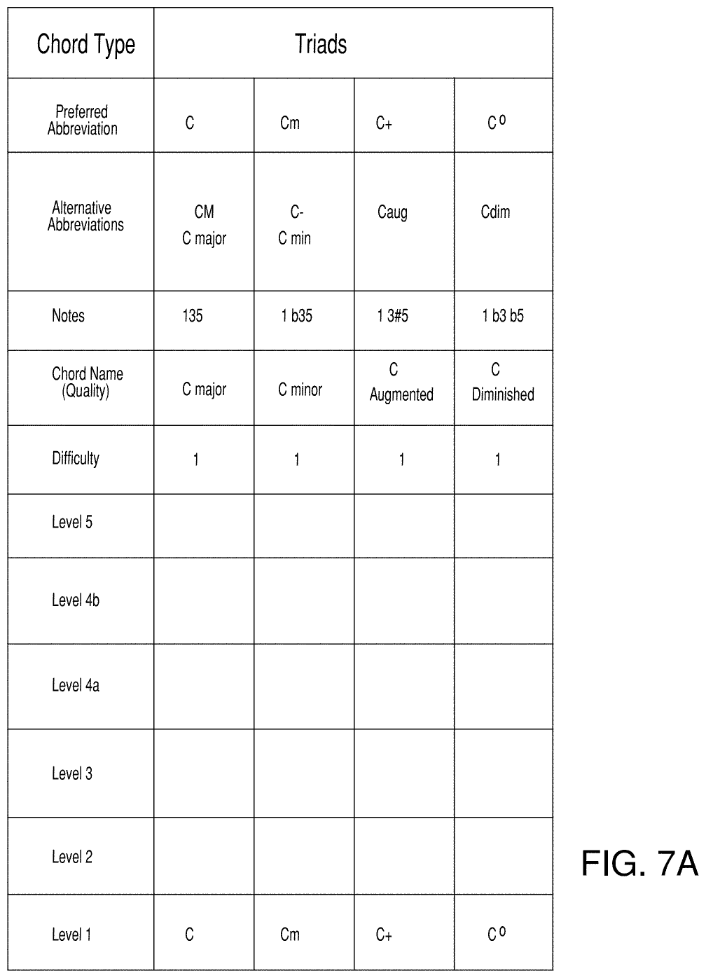

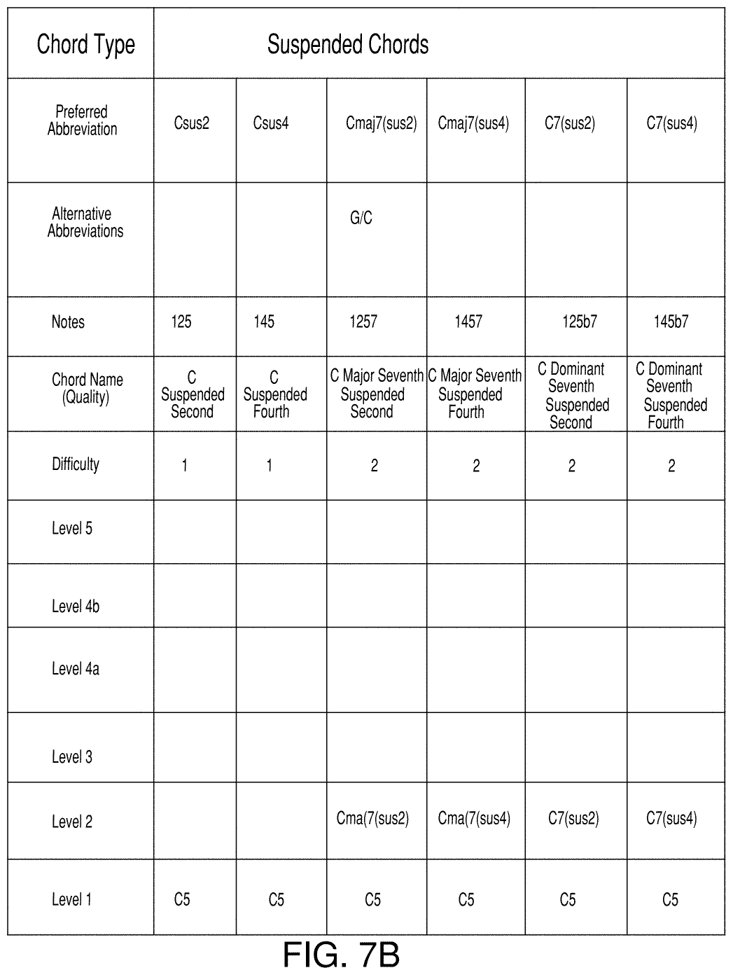

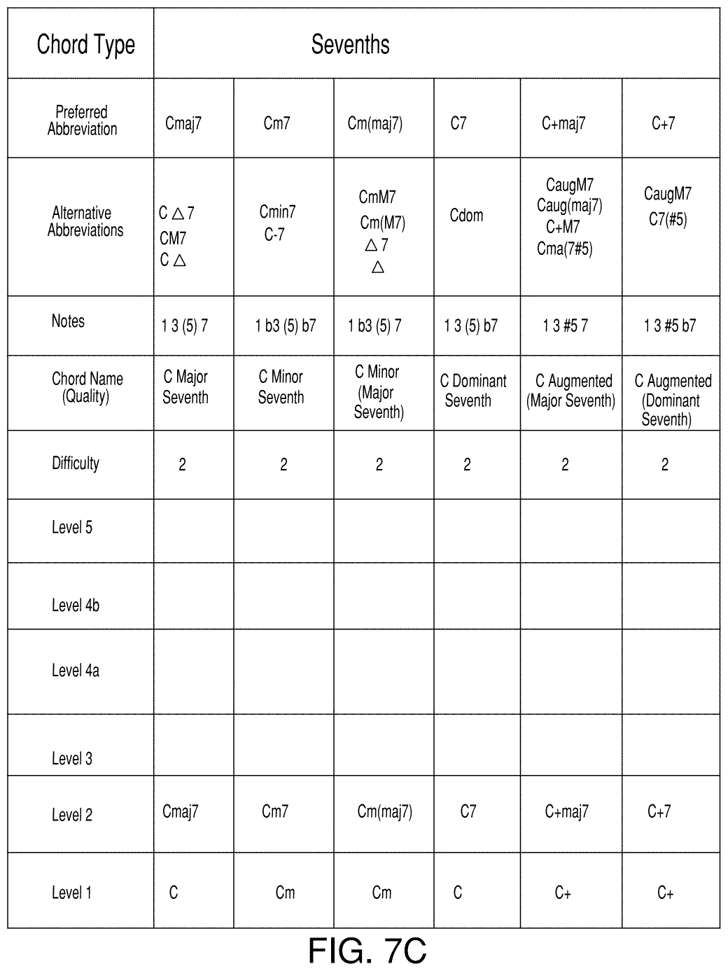

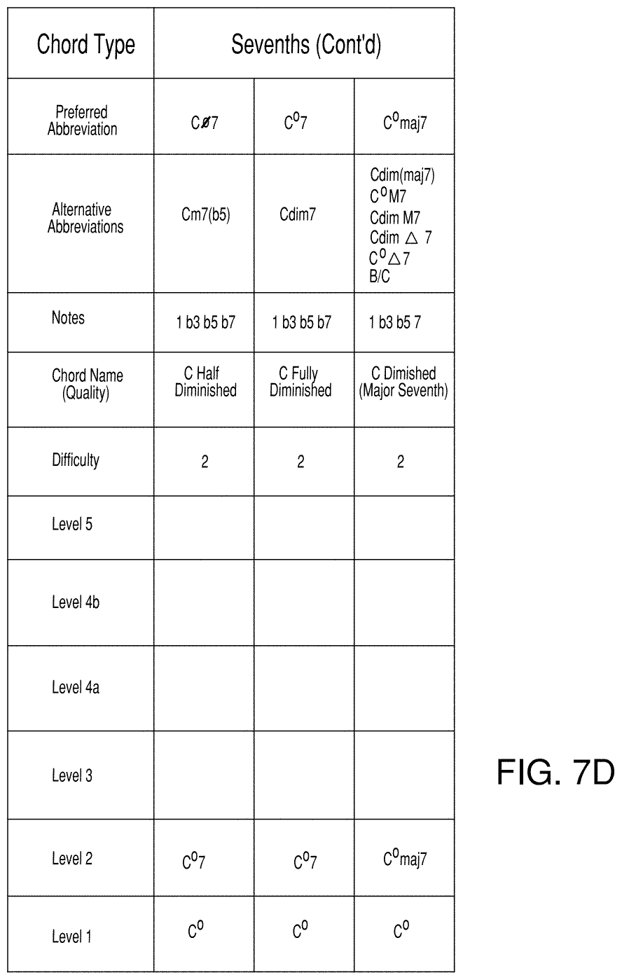

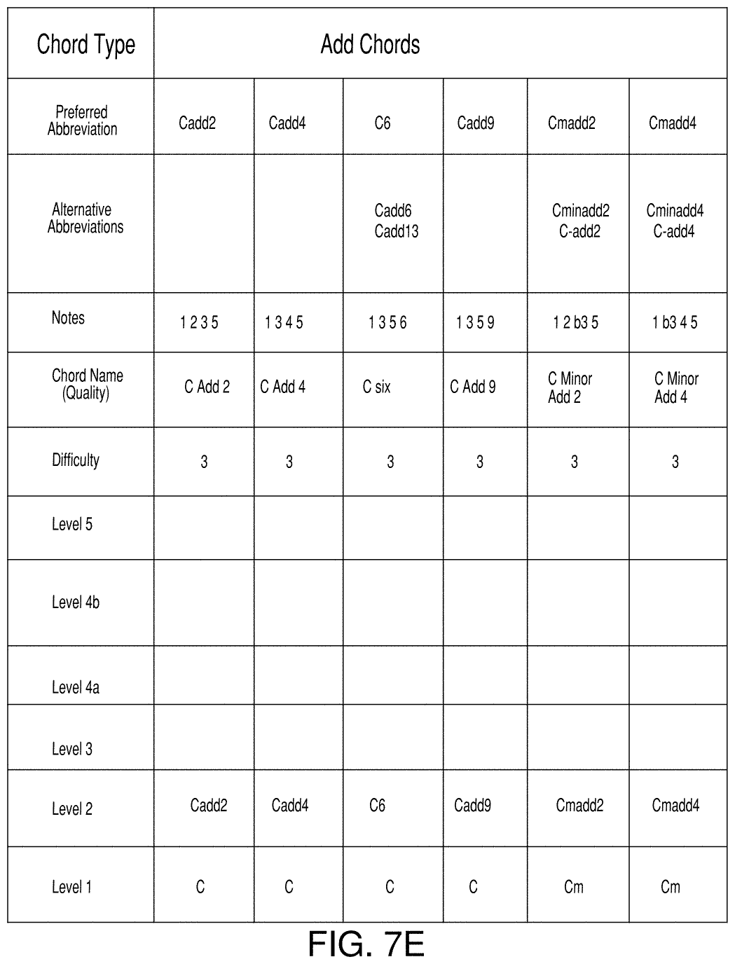

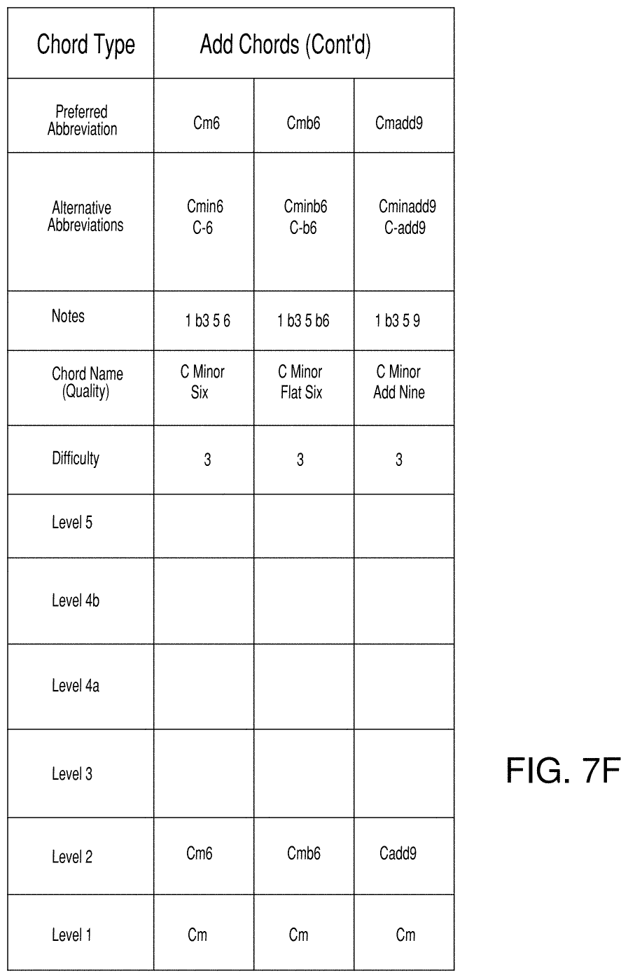

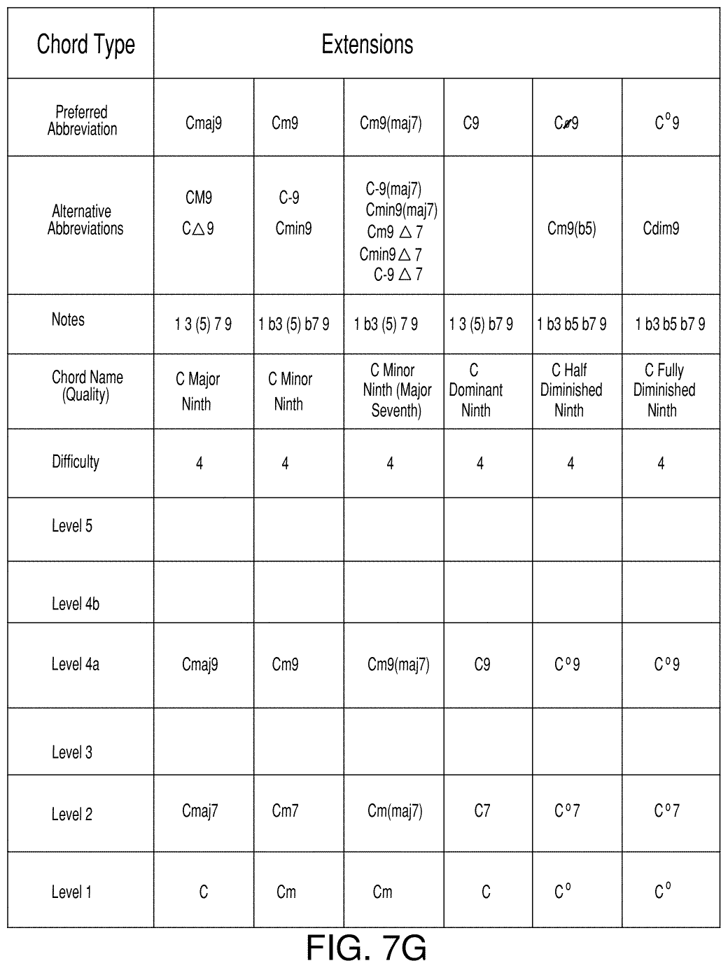

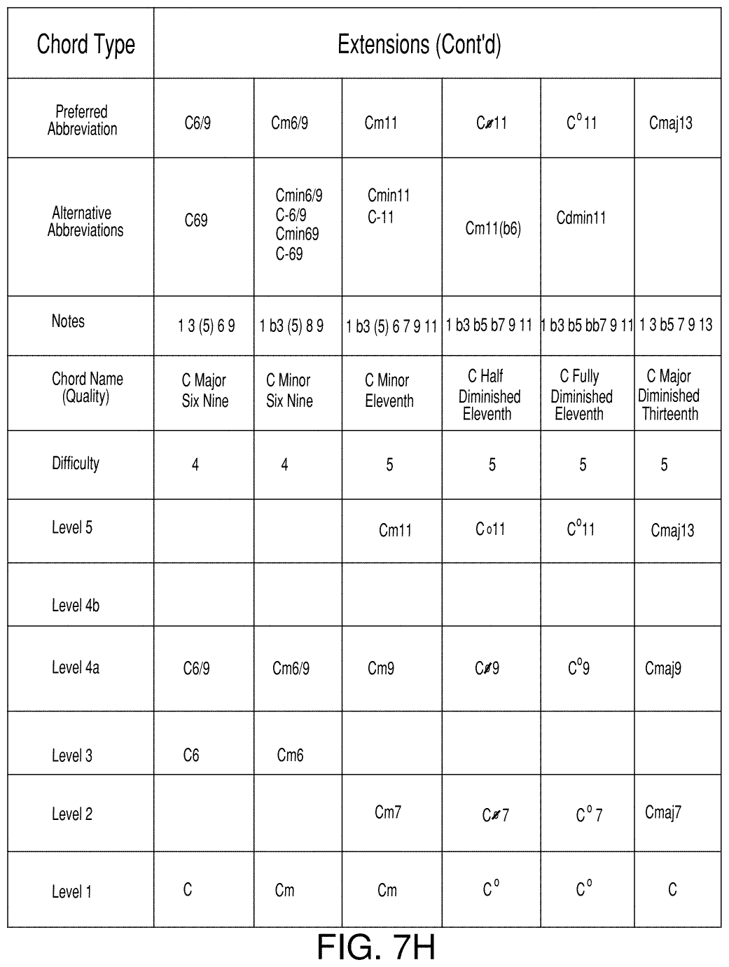

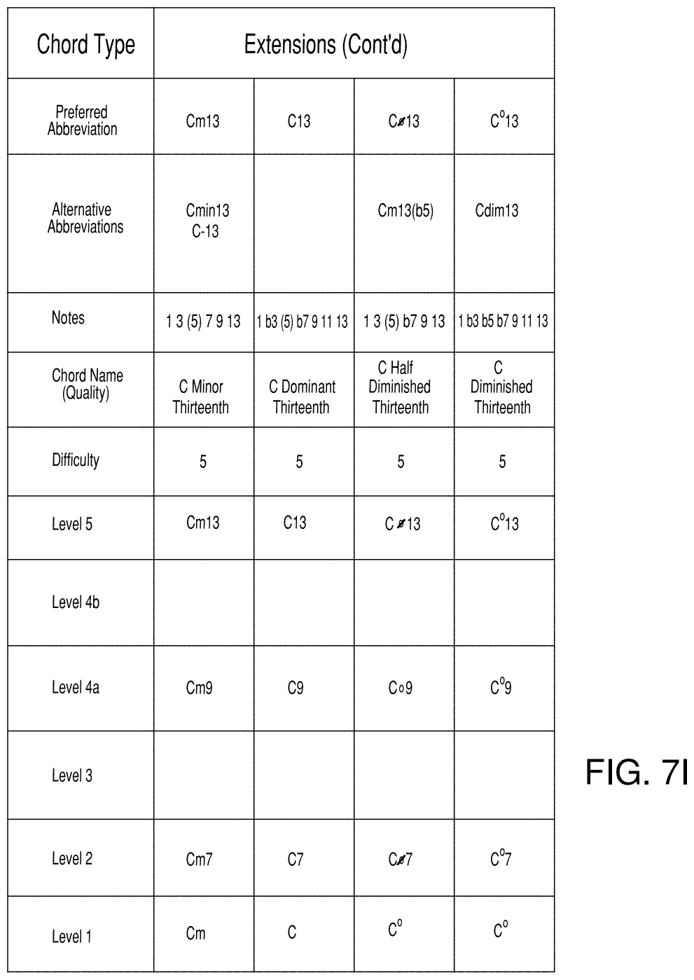

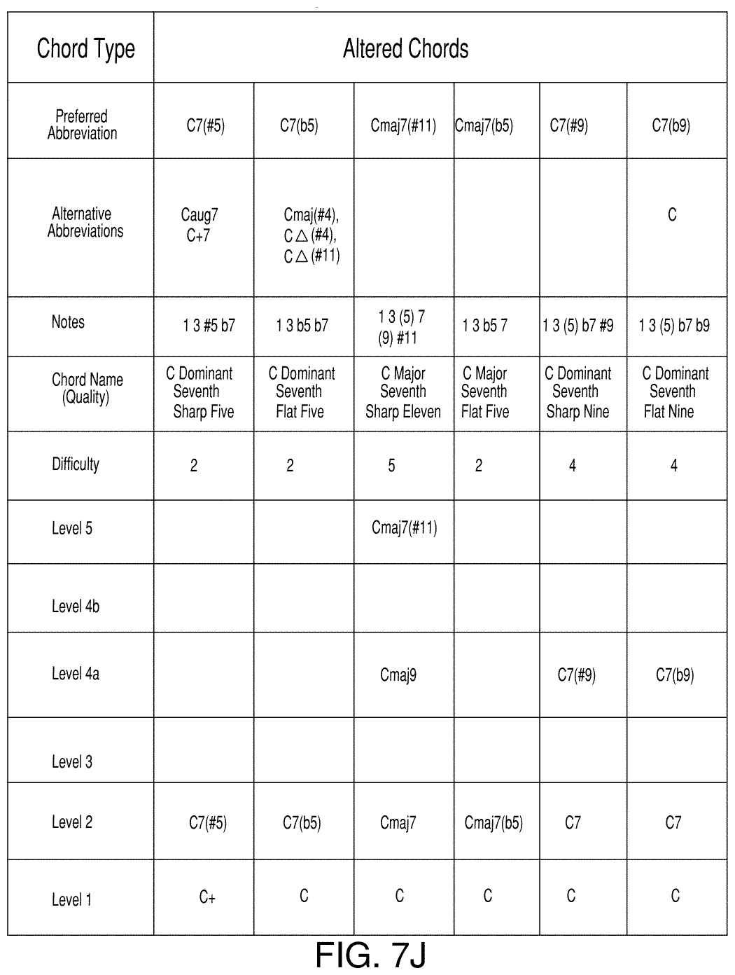

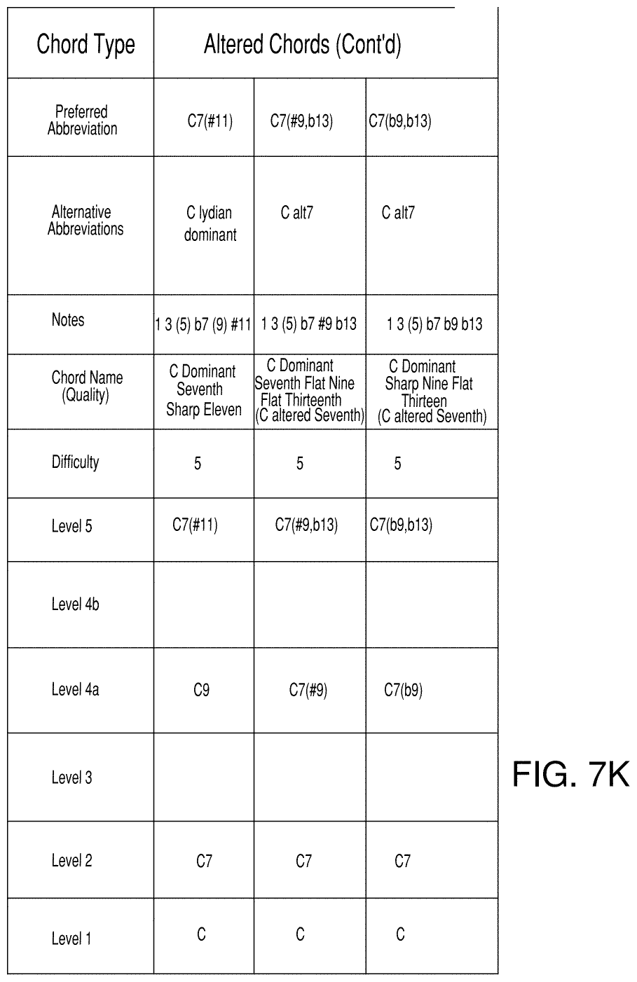

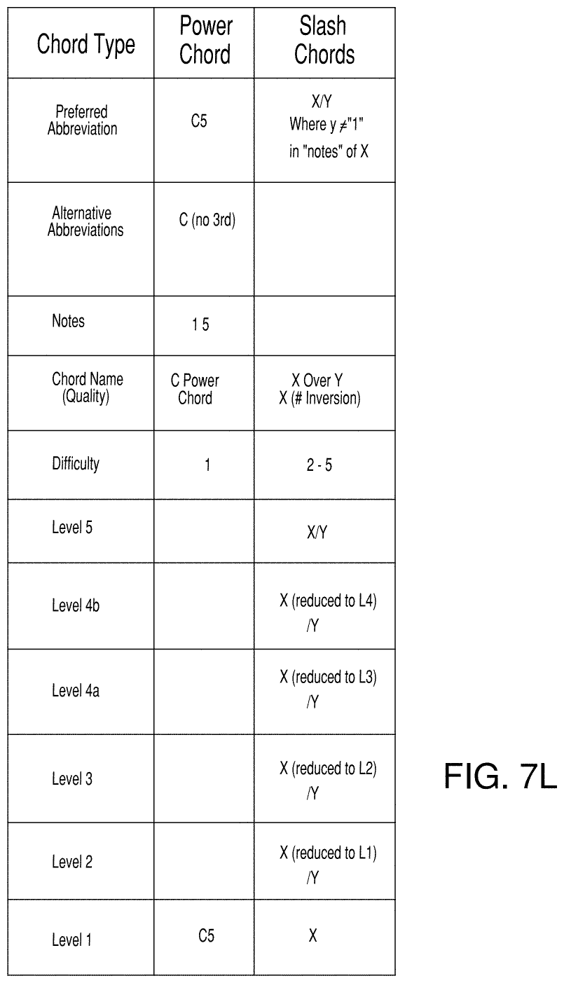

Further, the simplification rules of the preferred embodiment include chord simplification rules 142, 156, 170. The chord simplification rules of the preferred embodiment are shown in FIGS. 7A-7L. The chord simplification rules are aimed at simplifying the chords required of the user as necessary depending on skill level. Although some definitions differ, a chord is often recognized as a group of two or more (typically three) notes played at the same time. This invention is applicable to all types of musical chords of any definition. Chords provide the foundation of a piece and provide context with respect to feelings or emotions. In the case of instruments that only play one note at a time (for example a trumpet or flute, as compared to a piano or guitar), chords provide a data set of notes that can be played. Often, more complex chords result in fewer notes that can be played at the same time, while simpler chords result in more notes that can be played at the same time.

The arrangement simplification rules 124 may include a music generation step 172. The music generation step may generate music for instruments or parts that were not originally in the digital score file 110. Accordingly, it may provide a composition step. All categories of simplification rules — melody 118, chord 120, lead sheet 122, and arrangement 124 may include a fingerings and positions simplification step 134, 144, 158, 174. The fingerings and positions simplification step 134, 144, 158, 174 may provide guidance to the user with respect to suggested and/or necessary positions and/or fingers. For example, for fretted instruments, like guitar, it is likely that one can play the same note/pitch class on more than one position and/or string. For that reason, it is helpful to notate which position/string to play for the notes in the sheet music. Playing in a higher position (e.g. 7th fret) is typical as it allows the player the largest range for the most common notes. This requires more experience and more counting with the instrument, which can be difficult for beginners. On the other hand, playing in a lower position (e.g. 2nd fret) limits the range for the most common notes but is much easier to count. In some embodiments, such as the illustrated preferred embodiment, it is desirable to recommend the position best suited for the learner's skill level. When combined with range simplification, sheet music can become very achievable not just to read, but to play. Moreover, for most instruments, there is often more than one way to orient one's hands and fingers to play a particular musical passage. Providing fingerings for notes can help a learner play a passage not only easier, but healthier as well. Displaying fingerings frequently can be helpful to a beginner, and as they progress, can be displayed less frequently as to not obstruct the music. In preferred embodiments of the invention the digital score file 102 is a MIDI file 110. MIDI files allow the attachment of several types of information that can then be visualized as will be described later. In non-limiting examples, MIDI files can include information such as pitch, length, volume, etc. Fingering and/or position information, including but not limited to the examples discussed above, can be added to the MIDI file channels and then displayed when a visualization is generated.

As provided in FIG. 2, preferably, the above results in a simplified MIDI file 176. The simplified MIDI file 176 may then be subject to notation simplification rules. In its complete form, music notation can be an overwhelming amount of information. At each skill level the learner should be dealing with the appropriate amount of new information and this includes music notation. It is possible to simplify any music notation into its bare principles. In preferred embodiments, notation simplification is done through musicXML formatting. A header or a musicXML code may be used to format the visualization at each level.

The generated visualization 180 will vary based on the instrument, which is preferably inputted 112 at the beginning of the method for processing by the system. Depending on the level of the user and the instrument, certain aspects of musical notation will be displayed or not displayed. Tables 5-8 show which elements are displayed in the visualization for each level in preferred embodiments.

TABLE 5
1. Elements are displayed (“Yes”) and are not displayed (“No”) in the visualization for the
instrument piano in each level in preferred embodiments of the present invention.

| | Level 1 | Level 2a | Level 2b | Level 3 | Level 4a | Level 4b | Level 5 |
|---|---|---|---|---|---|---|---|
| Barlines | No | Yes | Yes | Yes | Yes | Yes | Yes |
| Noteheads | No | No | No | Yes | Yes | Yes | Yes |
| Durations | No | Yes | Yes | Yes | Yes | Yes | Yes |
| Flags | No | No | No | Yes | Yes | Yes | Yes |
| Key Signature | No | No | No | No | No | Yes | Yes |
| Time Signature | No | No | No | Yes | Yes | Yes | Yes |
| Clefs | No | Yes | Yes | Yes | Yes | Yes | Yes |
| Staff lines | No | No | No | No | Yes | Yes | Yes |
| Staff guides | No | No | No | No | Yes | Yes | Yes |
| String guides | No | No | No | No | No | No | No |
| Repeat signs | No | No | No | No | Yes | Yes | Yes |
| Rests | No | Yes | Yes | Yes | Yes | Yes | Yes |
| Accidentals | Yes | Yes | Yes | Yes | Yes | Yes | Yes |
| Dynamics | No | No | No | Yes | Yes | Yes | Yes |
| Articulations | No | No | No | No | Yes | Yes | Yes |
| Other symbols | No | No | No | No | Yes | Yes | Yes |

TABLE 6
Elements are displayed (“Yes”) and are not displayed (“No”) in the visualization for the instruments
acoustic and electric guitars in each level in preferred embodiments of the present invention.

| | Level 1 | Level 2a | Level 2b | Level 3 | Level 4a | Level 4b | Level 5 |
|---|---|---|---|---|---|---|---|
| Barlines | No | Yes | Yes | Yes | Yes | Yes | Yes |
| Noteheads | No | No | Yes | Yes | Yes | Yes | Yes |
| Durations | No | Yes | Yes | Yes | Yes | Yes | Yes |
| Flags | No | | Yes | Yes | Yes | Yes | Yes |
| Key Signature | No | No | No | No | No | Yes | Yes |
| Time Signature | No | No | No | Yes | Yes | Yes | Yes |
| Clefs | No | Yes | Yes | Yes | Yes | Yes | Yes |
| Staff lines | No | No | No | No | Yes | Yes | Yes |
| Staff guides | No | No | No | No | Yes | No | No |
| String guides | Yes | Yes | Yes | No | No | No | No |
| Repeat signs | No | No | No | No | Yes | Yes | Yes |
| Rests | No | | Yes | Yes | Yes | Yes | Yes |
| Accidentals | Yes | Yes | Yes | Yes | Yes | Yes | Yes |
| Dynamics | No | No | No | Yes | Yes | Yes | Yes |
| Articulations | No | No | No | No | Yes | Yes | Yes |
| Other symbols | No | No | No | No | Yes | Yes | Yes |

TABLE 7
Elements are displayed (“Yes”) and are not displayed (“No”) in the visualization for the
instrument ukulele in each level in preferred embodiments of the present invention.

| | Level 1 | Level 2a | Level 2b | Level 3 | Level 4a | Level 4b | Level 5 |
|---|---|---|---|---|---|---|---|
| Barlines | No | Yes | Yes | Yes | Yes | Yes | Yes |
| Noteheads | No | No | Yes | Yes | Yes | Yes | Yes |
| Durations | No | Yes | Yes | Yes | Yes | Yes | Yes |
| Flags | No | No | Yes | Yes | Yes | Yes | Yes |
| Key Signature | No | No | No | No | No | Yes | Yes |
| Time Signature | No | No | No | Yes | Yes | Yes | Yes |
| Clefs | No | Yes | Yes | Yes | Yes | Yes | Yes |
| Staff lines | No | No | No | No | Yes | Yes | Yes |
| Staff guides | No | No | No | No | Yes | Yes | No |
| String guides | Yes | Yes | Yes | No | No | No | No |
| Repeat signs | No | No | No | No | Yes | Yes | Yes |
| Rests | No | No | Yes | Yes | Yes | Yes | Yes |
| Accidentals | Yes | Yes | Yes | Yes | Yes | Yes | Yes |
| Dynamics | No | No | No | Yes | Yes | Yes | Yes |
| Articulations | No | No | No | No | Yes | Yes | Yes |
| Other symbols | No | No | No | No | Yes | Yes | Yes |

TABLE 8
Elements are displayed (“Yes”) and are not displayed (“No”) in the visualization for the
instrument electric bass in each level in preferred embodiments of the present invention.

| | Level 1 | Level 2a | Level 2b | Level 3 | Level 4a | Level 4b | Level 5 |
|---|---|---|---|---|---|---|---|
| Barlines | No | Yes | Yes | Yes | Yes | Yes | Yes |
| Noteheads | No | No | Yes | Yes | Yes | Yes | Yes |
| Durations | No | Yes | Yes | Yes | Yes | Yes | Yes |
| Flags | No | No | Yes | Yes | Yes | Yes | Yes |
| Key Signature | No | No | No | No | No | Yes | Yes |
| Time Signature | No | No | No | Yes | Yes | Yes | Yes |
| Clefs | No | Yes | Yes | Yes | Yes | Yes | Yes |
| Staff lines | No | No | No | No | Yes | Yes | Yes |
| Staff guides | No | No | No | No | Yes | Yes | No |
| String guides | Yes | Yes | Yes | No | No | No | No |
| Repeat signs | No | No | No | No | Yes | Yes | Yes |
| Rests | No | No | Yes | Yes | Yes | Yes | Yes |
| Accidentals | Yes | Yes | Yes | Yes | Yes | Yes | Yes |
| Dynamics | No | No | No | Yes | Yes | Yes | Yes |
| Articulations | No | No | No | No | Yes | Yes | Yes |
| Other symbols | No | No | No | No | Yes | Yes | Yes |

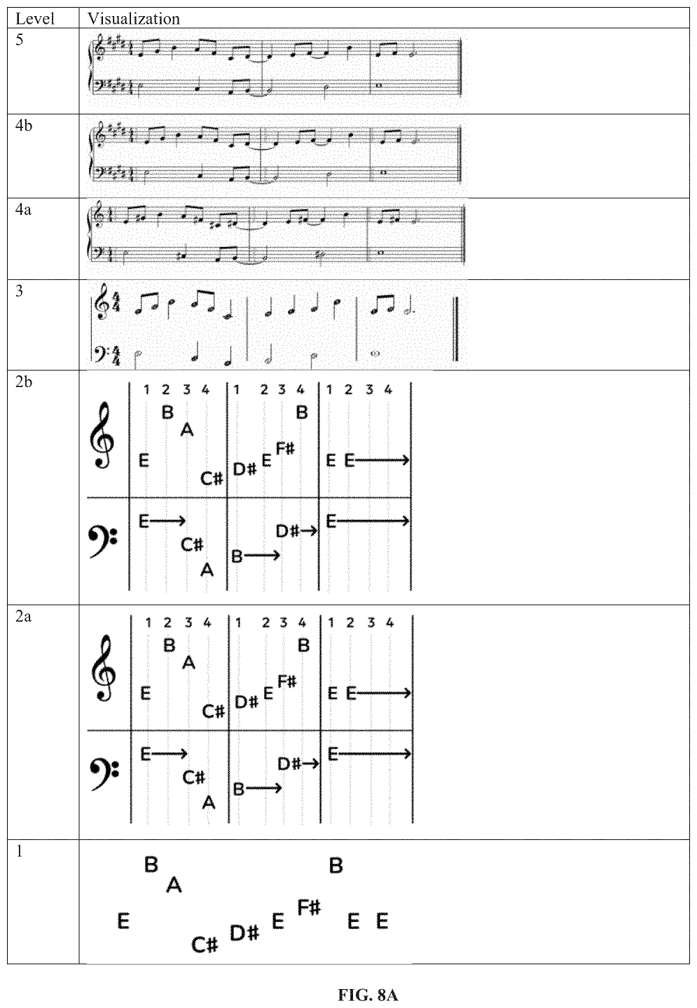

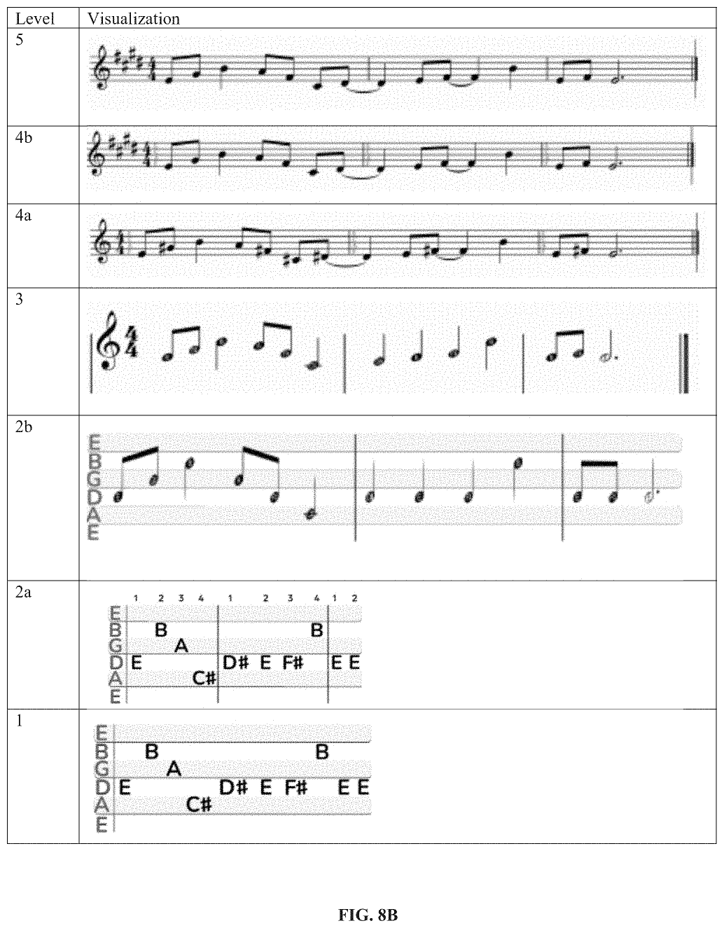

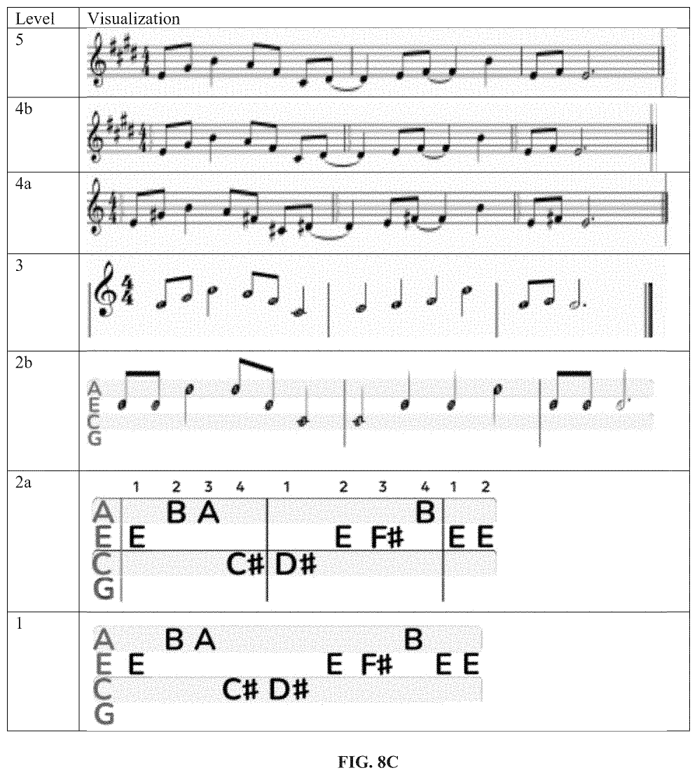

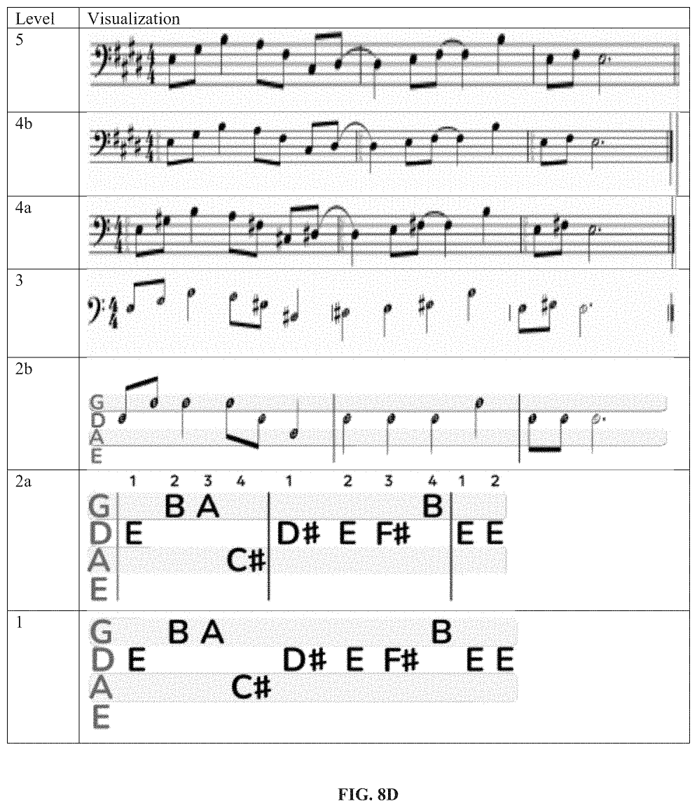

Moreover, FIGS. 8A-8D show the visualization output for these examples of instruments. Namely, FIG. 8A shows an example of piano visualization that corresponds to the rules presented in Table 3. FIG. 8B shows an example of acoustic and electric guitar visualization that corresponds to the rules presented in Table 4. FIG. 8C shows an example of ukulele visualization that corresponds to the rules present in Table 5. FIG. 8D shows an example of electric bass visualization that corresponds to the rules present in Table 6.

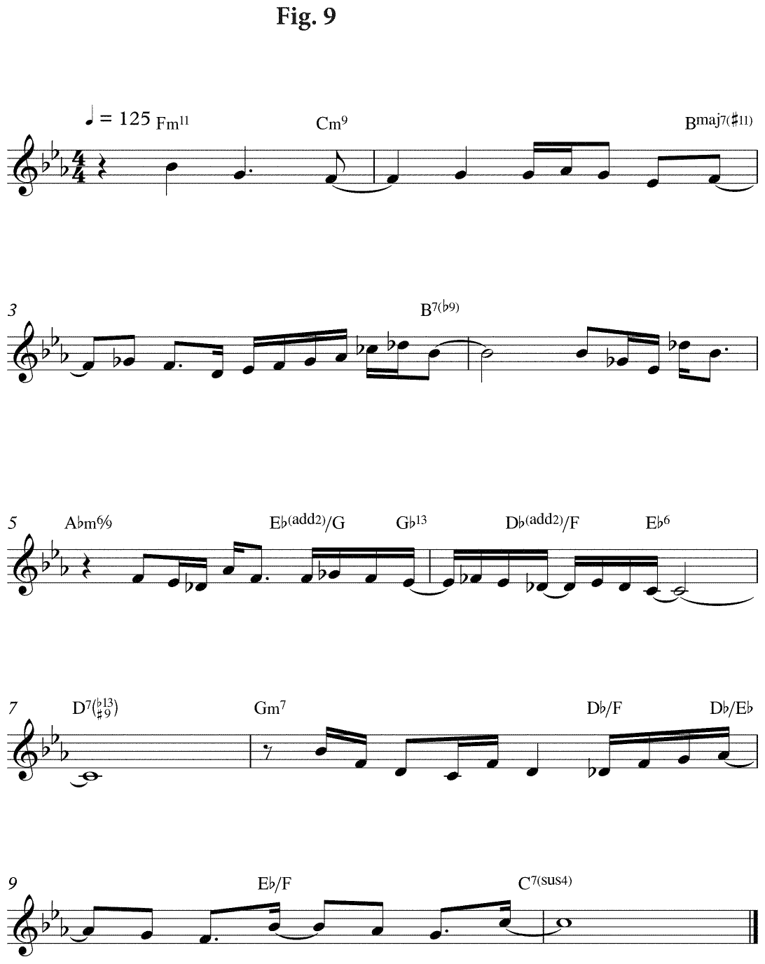

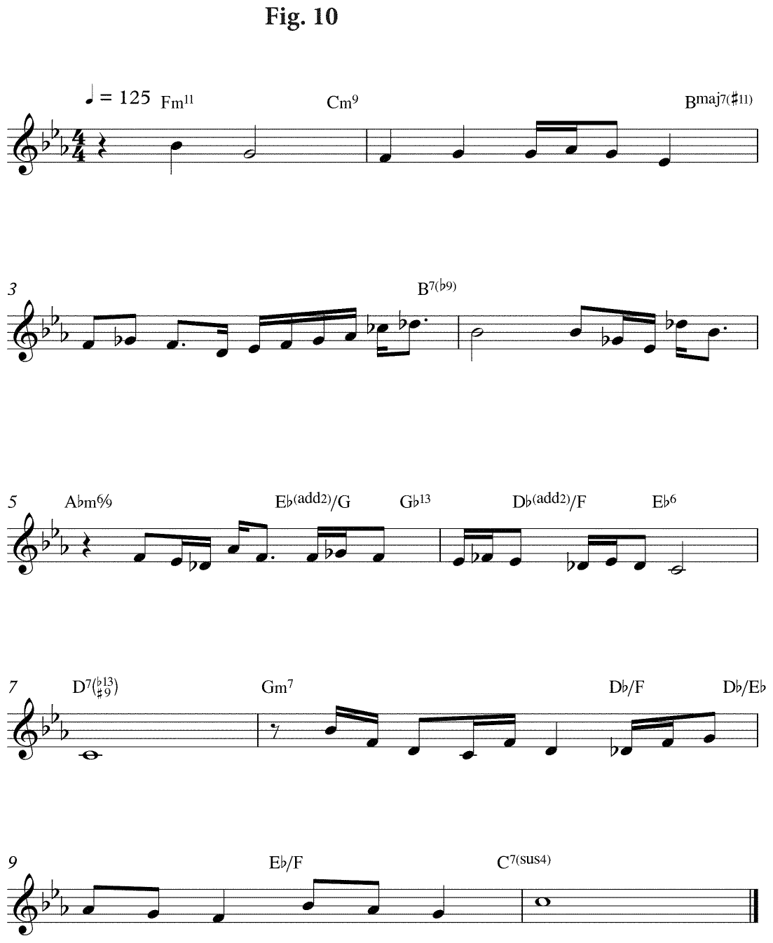

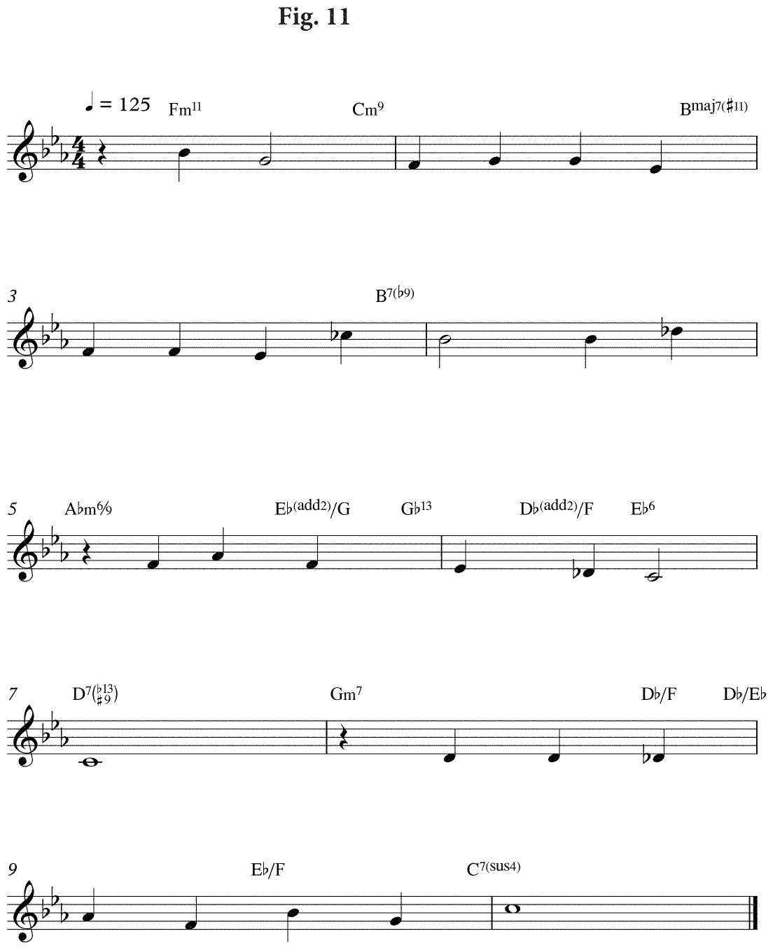

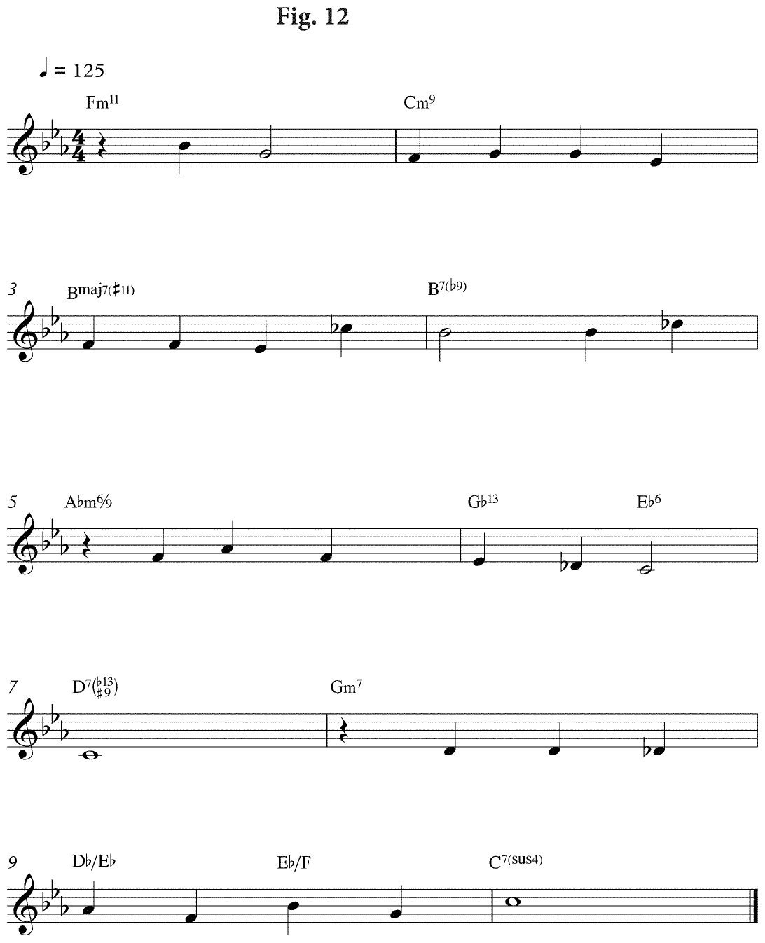

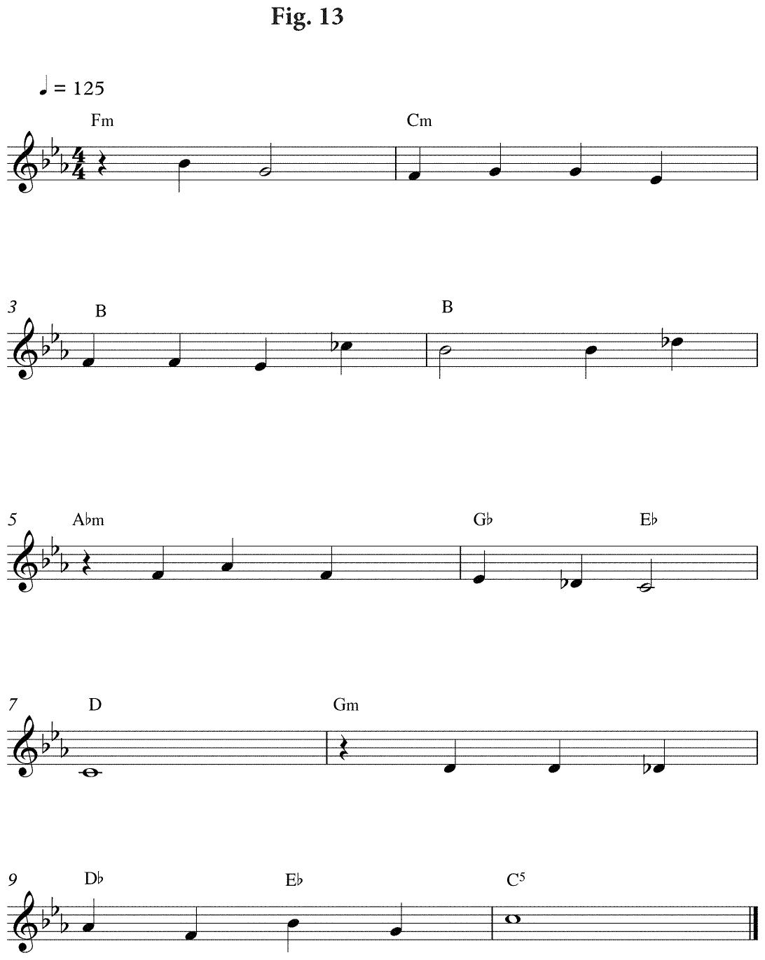

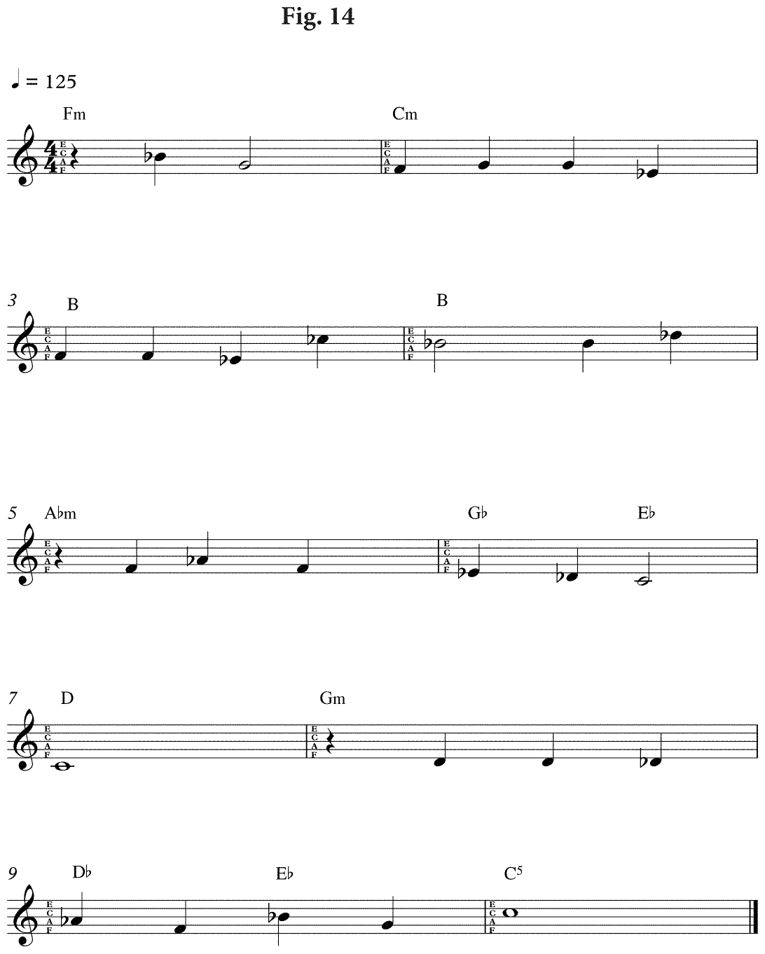

An example of the output of the present invention will now be provided across several skill levels. FIG. 9 shows a visualization of a section of an original digital score file. FIG. 10-14 show various steps in the simplification for Level 1. Referring to FIG. 2, in all types of simplification, the digital score file is first subjected to a song length simplification step 126, 136, 146, 160. In this example, only a single section of the digital score file is shown. Accordingly, the length of the music will not appear shorter. Second, all score types are subjected to tempo adjustments. In this case, referring to FIG. 9, the tempo of the digital score file is 125 bpm. Referring to Table 2, in the illustrated embodiment, the simplification is not adjusted at level 1 at this tempo. Next, before further simplification occurs, the ties are simplified as shown in FIG. 3. FIG. 10 illustrates the tie simplification step in this example. Turning next to FIG. 11, the rhythm simplification of the level 1 of the illustrated embodiment is shown. This would come at step 130 of FIG. 2. As discussed above, the same rhythm simplification can be used in the lead sheet 122 and arrangement 124 score types, for example at boxes 150 and 164. Moving to FIG. 12, the harmonic rhythm simplification is shown, which is found in step 140 of FIG. 2. FIG. 13 shows illustrates the chord simplification 142 of this example. As shown in FIG. 2 and discussed above, the harmonic rhythm simplification and chord simplification may also be found in the lead sheet 122 and arrangement 124 score type simplification, such as at boxes 154, 156, 168, 170. Lastly, with respect to level 1, the simplified notation 178 of this example is shown in FIG. 14.

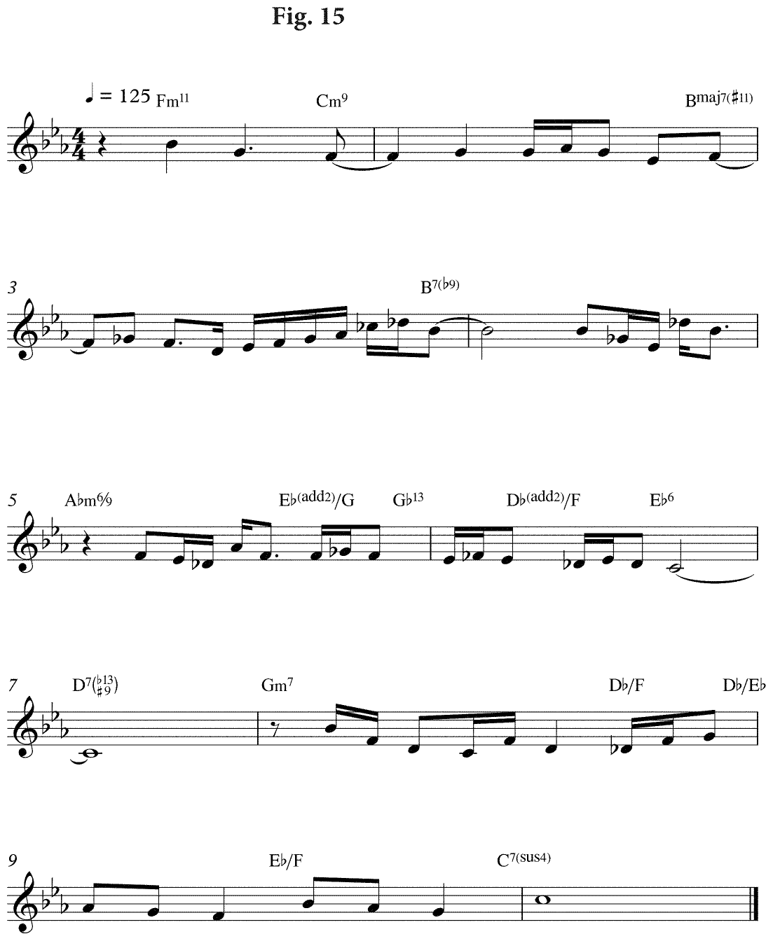

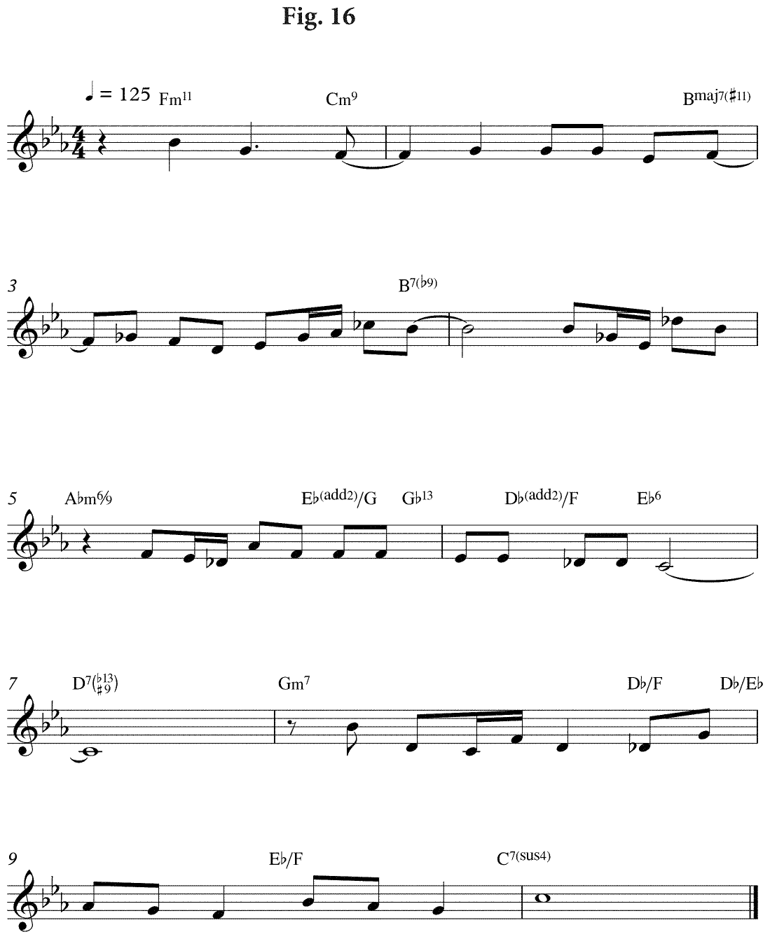

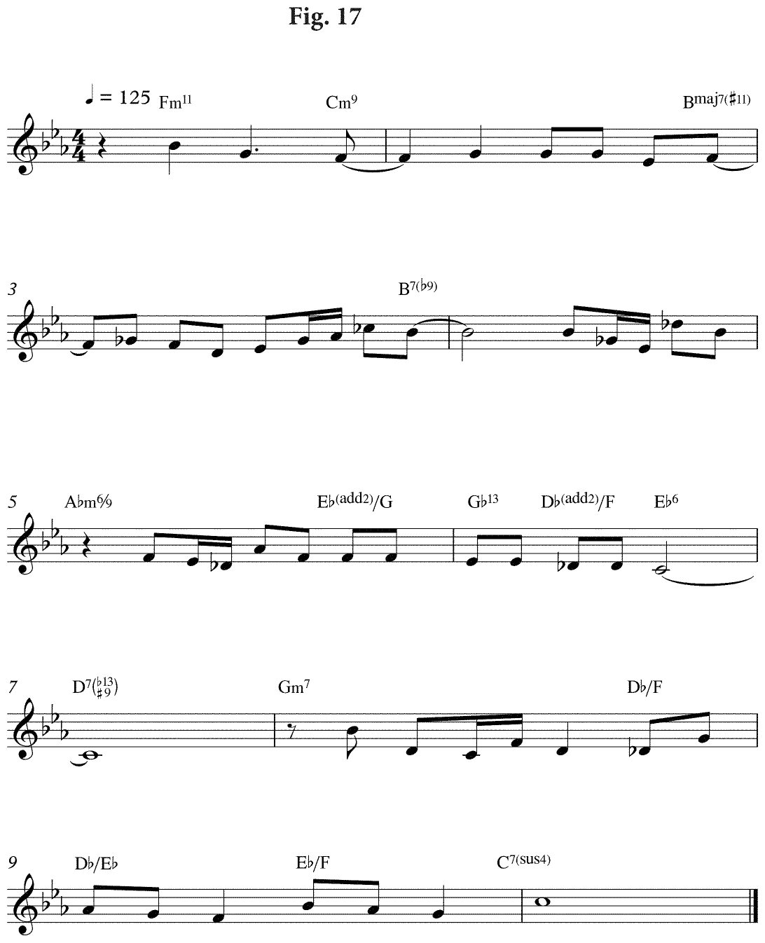

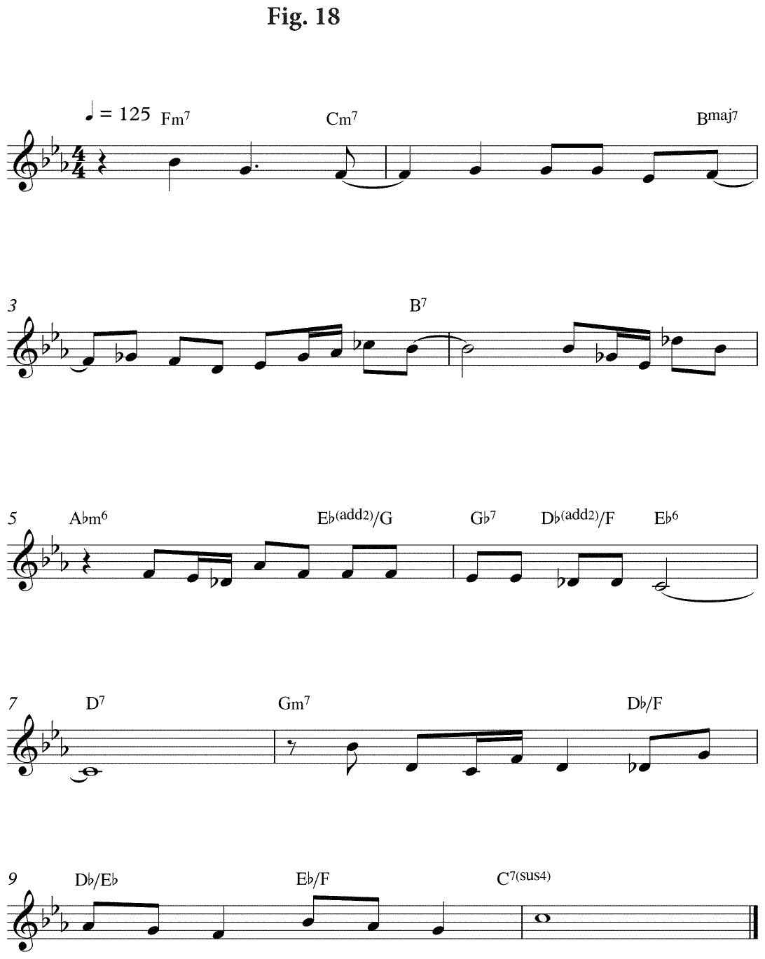

FIGS. 15-18 represent the output for level 3c of the illustrated embodiment. Specifically, FIG. 15 shows the simplification of the ties at level 3c. As discussed above, before reaching the tie simplification, the digital score file will be subjected to execution of the song length simplification and tempo adjustment rules. After the ties are simplified, if the melody 118 score type is selected, the digital score file will be subjected to rhythm simplification 130. FIG. 16 shows rhythm simplification for level 3c in this example. As discussed above, the same rhythm simplification can be used in the lead sheet 122 and arrangement 124 score types, for example at boxes 150 and 164. If the chord 120 score type is selected, the harmonic rhythm is simplified 140. The simplified harmonic rhythm in this example at level 3c is shown in FIG. 17. Lastly, FIG. 18 shows the chord simplification 142 of level 3c in this example. As shown in FIG. 2 and discussed above, the harmonic rhythm simplification and chord simplification may also be found in the lead sheet 122 and arrangement 124 score type simplification, such as at boxes 154, 156, 168, 170.

Lastly, FIG. 9 represents the Level 5 simplification in this example. As discussed above, FIG. 9 is the original digital score file. In this example, the output in Level 5 is consistent with the original digital score file.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements, and/or substantial equivalents.

1. A computer implemented method for transforming a digital score file into one or more of a plurality of levels of simplified visualization outputs, comprising:
a. Receiving at least one digital score file;
b. Receiving one or more inputs related to said plurality of simplification levels;
c. Executing one or more executable instructions located on at least one non-transitory memory, wherein said one or more executable instructions are configured to cause a processor to:
i. Transcribe said digital score file into a digital score file transcription;
ii. Execute one or more simplification instructions on said digital score file transcription;
iii. Generate one or more simplified visualization outputs.

2. The method of claim 1 wherein said one or more executable instructions further includes generating one or more simplified digital score files and then generating said one or more simplified visualization outputs from said one or more simplified digital score files.

3. The method of claim 1 wherein said one or more simplification instructions includes at least one of rhythm simplification instructions and harmonic rhythm simplification instructions.

4. The method of claim 1 wherein said one or more simplification instructions includes song length simplification instructions.

5. The method of claim 4 wherein said one or more simplification instructions further includes tempo adjustment simplification instructions.

6. The method of claim 5 wherein said one or more simplification instructions further includes tie simplification instructions.

7. The method of claim 6 wherein said one or more simplification instructions includes at least one of rhythm simplification instructions and harmonic rhythm simplification instructions.

8. The method of claim 7 wherein said one or more simplification instructions includes harmonic rhythm simplification instructions and further includes chord simplification instructions.

9. The method of claim 7 wherein said one or more simplification instructions includes both rhythm simplification instructions and harmonic rhythm simplification instructions and further includes at least one or range simplification instructions and chord simplification instructions.

10. The method of claim 1 wherein said visualization output is musical notation including at least one of melody music notation, chord music notation, lead sheet music notation, or arrangement music notation.

11. A computer implemented method for transforming a digital score file into one or more of a plurality of levels of simplified visualization outputs, comprising:
a. Receiving at least one digital score file;
b. Receiving one or more inputs related to said plurality of simplification levels;
c. Receiving one or more inputs related to a desired score type of said simplified visualization output;
d. Executing, by a processor, one or more song length simplification rules;
e. Executing, by a processor, one or more tempo adjustment simplification rules;
f. Executing, by a processor, one or more tie simplification rules;
g. Executing, by a processor, at least one of rhythm simplification rules and harmonic rhythm simplification rules;
h. Generating at least one simplified visualization output.

12. The method of claim 12 further comprising transcribing said digital score file prior to executing any of said simplification rules and wherein said simplification rules are executed on a digital score transcription.

13. The method of claim 12 further comprising generating at least one simplified digital score file.

14. The method of claim 13 wherein said at least one simplified visualization output is generated from said at least one simplified digital score file.

15. A system for transforming a digital score file into one or more of a plurality of levels of simplified visualization outputs, comprising:
a. At least one display device;
b. A non-transitory memory having instructions embedded thereon; and
c. A processor in communication with said non-transitory memory and the at least one display device, said processor configured to access said instructions to perform or direct steps, the steps comprising:
i. Receiving at least one digital score file;
ii. Receiving one or more inputs related to said plurality of simplification levels;
iii. Executing, by a processor, one or more song length simplification rules;
iv. Executing, by a processor, one or more tempo adjustment simplification rules;
v. Executing, by a processor, one or more tie simplification rules;
vi. Executing, by a processor, at least one of rhythm simplification rules and harmonic rhythm simplification rules;
vii. Generating at least one simplified visualization output.
viii. Displaying said at least one simplified visualization output on said display device.
